(19) United States
(12) Patent Application Publication
(10) Pub. No.: US 2008/0188283 A1
(43) Pub. Date: Aug. 7, 2008

(54) SLOT MACHINE AND PLAYING METHOD THEREOF

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/019,050

(22) Filed: Jan. 24, 2008

(30) Foreign Application Priority Data
Jan. 26, 2007 (JP) JP2007-016391

(51) Int. Cl. A63F 13/00

(52) U.S. Cl. 463/20

(57) ABSTRACT

A slot machine comprises a display, a shutter and a controller. The display has slot game areas including a slot game area provided with mechanical reels and slot game areas provided with a liquid crystal display panel and displays a slot game on each of the slot game areas. The shutter is opened to expose the mechanical reels for execution the slot game on the slot game area provided with the mechanical reels when the slot game executed on any one of the slot game areas has brought the outcome. The shutter is closed to hide the mechanical reels when the slot game on slot game area provided with the mechanical reels has ended. The slot machine can provide a player with an expectation and producing a superior effect to enhance entertaining feature.

### CROSS-REFERENCE TO RELATED APPLICATION

This application is based upon the prior Japanese Patent Application No. 2007-016391, filed on Jan. 26, 2007, the entire contents of which are incorporated herein by reference.

This application is related to co-pending U.S. patent application entitled “SLOT MACHINE AND PLAYING METHOD THEREOF” referred to as the prior Japanese Patent Application No. 2006-337480, filed in Japan on Dec. 14, 2006, co-pending U.S. patent application entitled “SLOT MACHINE AND PLAYING METHOD THEREOF” referred to as the prior Japanese Patent Application No. 2006-337540, filed in Japan on Dec. 14, 2006, co-pending U.S. patent application entitled “SLOT MACHINE AND PLAYING METHOD THEREOF” referred to as the prior Japanese Patent Application No. 2006-337541, filed in Japan on Dec. 14, 2006, co-pending U.S. patent application entitled “SLOT MACHINE AND PLAYING METHOD THEREOF” referred to as the prior Japanese Patent Application No. 2006-337556, filed in Japan on Dec. 14, 2006, co-pending U.S. patent application entitled “SLOT MACHINE AND PLAYING METHOD THEREOF” referred to as the prior Japanese Patent Application No. 2006-343150, filed in Japan on Dec. 20, 2006, co-pending U.S. patent application entitled “SLOT MACHINE AND PLAYING METHOD THEREOF” referred to as the prior Japanese Patent Application No. 2007-012415, filed in Japan on Jan. 23, 2007, co-pending U.S. patent application entitled “SLOT MACHINE AND CONTROL METHOD THEREOF” referred to as the prior Japanese Patent Application No. 2007-012628, filed in Japan on Jan. 23, 2007, and co-pending U.S. patent application entitled “SLOT MACHINE AND CONTROL METHOD THEREOF” referred to as the prior Japanese Patent Application No. 2007-012636, filed in Japan on Jan. 23, 2007, which are assigned to the assignee of the present invention. The teachings of the co-pending applications are incorporated herein by reference to the extent they do not conflict with the teaching herein.

### BACKGROUND OF THE INVENTION

1. Field of the Invention

The present invention relates to a slot machine, with which gaming media such as coins and so on are used for game play, and a playing method thereof.

2. Description of the Related Art

In a conventional slot machine, mechanical reels (e.g., three reels), on each of which symbols are drawn, spin when a player inserts a medal(s) into a medal insertion slot and then presses a start button. The reels stop after a predetermined time has elapsed. At this time, a payout is awarded to the player according to the number of inserted medals if a winning symbol combination achieved on a preset payline. Alternatively, a payout is awarded to the player according to the number of inserted medals if a predetermined number of scatter symbols displayed.

On the other hand, in the gaming machine described in U.S. Pat. No. 6,855,052, a plurality of wheels provided above the reels begins to spin sequentially and then stops if a preset symbol combination has displayed on the reels after the reels has stopped. A large amount payout is awarded if the stopped wheels have brought a predetermined outcome.

### SUMMARY OF THE INVENTION

The present inventors have thought that provision of a certain slot machine is desired, with which a player can play a plurality of slot games instead of only one slot game by one time insertion of a medal(s) as described above. The slot machine can further stimulate the desire to play games of the player. Therefore, an object of the present invention is to provide a slot machine and a playing method thereof capable of providing a player with an expectation and producing a superior effect to enhance entertaining feature.

A first aspect of the present invention provides a slot machine which comprises: a display which has slot game areas including a slot game area provided with mechanical reels and a slot game area provided with a liquid crystal display panel and displays a slot game on each of the slot game areas; a shutter which is opened to expose the mechanical reels and closed to hide the mechanical reels in the slot game on the slot game area provided with the mechanical reels; and a controller. The slot game is a game in which symbols had been displayed on each of the slot game areas are rearranged. The controller is operable to (a) execute the slot game on each of the slot game areas, and (b) open the shutter in order to expose the mechanical reels for executing the slot game on the slot game area provided with the mechanical reels.

According to the first aspect of the present invention, the slot game is executed on the slot game area provided with the mechanical reels which is exposed/hidden by the shutter. The shutter is not used for the slot game on the slot game area provided with the liquid crystal display panel. Specifically, the mechanical reels hidden by the closed shutter are exposed when the shutter has been opened to execute the slot game.

Therefore, it is possible to provide a player with an expectation for the slot game with the mechanical reels by a presentation of exposing the mechanical reels. Further, it is possible to produce a superior effect to enhance entertaining feature.

It is preferable that the controller is operable to execute (b) when the slot game executed in (a) has brought an outcome in which a prescribed condition has been met. Here, it is further preferable that the slot game areas include the slot game area provided with mechanical reels and plural slot game areas provided with the liquid crystal display panel, and the controller is operable to execute the slot game on each of the slot game areas provided with the liquid crystal display panel in (a), to open the shutter in order to expose the mechanical reels in (b) when the slot game executed in (a) on any one of the slot game areas has brought the outcome, and (c) to execute the slot game on the slot game area provided with the mechanical reels with the shutter opened.

Here, it is further preferable that the outcome is that a winning combination has been achieved in the slot game executed in (a). Especially, it is further preferable that the outcome is that a specific winning combination has been achieved among plural kinds of winning combinations in the slot game executed in (a).

It is preferable that the shutter is provided with a display device capable of displaying a video shutter, and the display device displays the video shutter opened to expose the mechanical reels and displays the video shutter closed to hide the mechanical reels.

A second aspect of the present invention provides a slot machine which comprises: a display which has slot game areas including a slot game area provided with mechanical reels and a slot game area provided with a liquid crystal display panel and displays a slot game on each of the slot game areas; a shutter which is opened to expose the mechanical reels and closed to hide the mechanical reels in the slot game on the slot game area provided with the mechanical reels; and a controller. The slot game is a game in which symbols had been displayed on each of the slot game areas are rearranged. The controller is operable to (a) execute the slot game on the slot game area provided with the liquid crystal display panel, (b) open the shutter in order to expose the mechanical reels when the slot game executed in (a) has brought an outcome in which a prescribed condition has been met, and (c) execute the slot game on the slot game area provided with the mechanical reels with the shutter opened.

According to the second aspect of the present invention, the slot game is executed on the slot game area provided with the mechanical reels which is exposed/hidden by the shutter. The shutter is not used for the slot game on the slot game area provided with the liquid crystal display panel. Specifically, the mechanical reels hidden by the closed shutter are exposed when the shutter has been opened to execute the slot game. Note that, the slot game is executed on the slot game area provided with the mechanical reels only when a prescribed condition has been met in the slot game on the slot game area provided with the liquid crystal display panel.

Therefore, it is possible to provide a player with an expectation for the outcome in which the prescribed condition has been met in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the controller is operable to execute the slot game on each of the slot game areas provided with the liquid crystal display panel in (a), and to open the shutter in order to expose the mechanical reels in (b) when the slot game executed in (a) on any one of the slot game areas has brought the outcome.

According to this preferable configuration, the slot game is executed on the slot game area provided with the mechanical reels which is exposed/hidden by the shutter when the slot game executed on any one of the slot game areas has brought the outcome. The shutter is not used for the slot games on the slot game areas provided with the liquid crystal display panel. Therefore, a possibility of the slot game by the mechanical reels is raised.

Therefore, it is possible to provide a high expectation for the slot game on the slot game area provided with the mechanical reels by a presentation of exposing the mechanical reels.

It is preferable that the shutter is provided with a display device capable of displaying a video shutter, and the display device displays the video shutter opened to expose the mechanical reels and displays the video shutter closed to hide the mechanical reels.

According to this preferable configuration, the mechanical reels is exposed by opening the video shutter displayed on the display device and hidden by closing the video shutter displayed on the display device.

Therefore, it is possible to produce various effects of exposing and hiding the mechanical reels by devising a presentation of the video shutter on the display device.

A third aspect of the present invention provides a slot machine which comprises: a display which has slot game areas including a slot game area provided with mechanical reels and a slot game area provided with a liquid crystal display panel and displays a slot game on each of the slot game areas; a shutter which is opened to expose the mechanical reels and closed to hide the mechanical reels in the slot game on the slot game area provided with the mechanical reels; and a controller. The slot game is a game in which symbols had been displayed on each of the slot game areas are rearranged. The controller is operable to (a) execute the slot game on the slot game area provided with the liquid crystal display panel, (b) open the shutter in order to expose the mechanical reels when a winning combination has been achieved in the slot game executed in (a), and (c) execute the slot game on the slot game area provided with the mechanical reels with the shutter opened.

According to the third aspect of the present invention, the slot game is executed on the slot game area provided with the mechanical reels which is exposed/hidden by the shutter. The shutter is not used for the slot game on the slot game area provided with the liquid crystal display panel. Specifically, the mechanical reels hidden by the closed shutter are exposed when the shutter has been opened to execute the slot game. Note that, the slot game is executed on the slot game area provided with the mechanical reels only when a winning combination has been achieved in the slot game on the slot game area provided with the liquid crystal display panel.

Therefore, it is possible to provide a player with an expectation for an achievement of a winning combination in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the controller is operable to execute the slot game on each of the slot game areas provided with the liquid crystal display panel in (a), and to open the shutter in order to expose the mechanical reels in (b) when a winning combination has been achieved in the slot game executed in (a) on any one of the slot game areas.

According to this preferable configuration, the slot game is executed on the slot game area provided with the mechanical reels which is exposed/hidden by the shutter when a winning combination has been achieved in the slot game on any one of the slot game areas has brought the outcome. The shutter is not used for the slot games on the slot game areas provided with the liquid crystal display panel. Therefore, a possibility of the slot game by the mechanical reels is raised.

Therefore, it is possible to provide a high expectation for the slot game on the slot game area provided with the mechanical reels by a presentation of exposing the mechanical reels.

It is preferable that the shutter is provided with a display device capable of displaying a video shutter, and the display device displays the video shutter opened to expose the mechanical reels and displays the video shutter closed to hide the mechanical reels.

According to this preferable configuration, the mechanical reels is exposed by opening the video shutter displayed on the display device and hidden by closing the video shutter displayed on the display device.

Therefore, it is possible to produce various effects of exposing and hiding the mechanical reels by devising a presentation of the video shutter on the display device.

A fourth aspect of the present invention provides a slot machine which comprises: a display which has slot game areas including a slot game area provided with mechanical reels and a slot game area provided with a liquid crystal display panel and displays a slot game on each of the slot game areas; a shutter which is opened to expose the mechanical reels and closed to hide the mechanical reels in the slot game on the slot game area provided with the mechanical reels; and a controller. The slot game is a game in which symbols had been displayed on each of the slot game areas are rearranged. The controller is operable to (a) execute the slot game on the slot game area provided with the liquid crystal display panel, (b) open the shutter in order to expose the mechanical reels when a specific winning combination has been achieved among plural kinds of winning combinations in the slot game executed in (a), and (c) execute the slot game on the slot game area provided with the mechanical reels with the shutter opened.

According to the fourth aspect of the present invention, the slot game is executed on the slot game area provided with the mechanical reels which is exposed/hidden by the shutter. The shutter is not used for the slot game on the slot game area provided with the liquid crystal display panel. Specifically, the mechanical reels hidden by the closed shutter are exposed when the shutter has been opened to execute the slot game. Note that, the slot game is executed on the slot game area provided with the mechanical reels only when a specific winning combination has been achieved among plural kinds of winning combinations in the slot game on the slot game area provided with the liquid crystal display panel.

Therefore, it is possible to provide a player with an expectation for an achievement of a specific winning combination among plural kinds of winning combinations in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the controller is operable to execute the slot game on each of the slot game areas provided with the liquid crystal display panel in (a), and to open the shutter in order to expose the mechanical reels in (b) when a specific winning combination has been achieved among plural kinds of winning combinations in the slot game executed in (a) on any one of the slot game areas.

According to this preferable configuration, the slot game is executed on the slot game area provided with the mechanical reels which is exposed/hidden by the shutter when a specific winning combination has been achieved among plural kinds of winning combinations in the slot game on any one of the slot game areas has brought the outcome. The shutter is not used for the slot games on the slot game areas provided with the liquid crystal display panel. Therefore, a possibility of the slot game by the mechanical reels is raised.

Therefore, it is possible to provide a high expectation for the slot game on the slot game area provided with the mechanical reels by a presentation of exposing the mechanical reels.

It is preferable that the shutter is provided with a display device capable of displaying a video shutter, and the display device displays the video shutter opened to expose the mechanical reels and displays the video shutter closed to hide the mechanical reels.

According to this preferable configuration, the mechanical reels is exposed by opening the video shutter displayed on the display device and hidden by closing the video shutter displayed on the display device.

Therefore, it is possible to produce various effects of exposing and hiding the mechanical reels by devising a presentation of the video shutter on the display device.

A fifth aspect of the present invention provides a playing method of a slot machine for playing a slot game. The slot game is a game in which symbols had been displayed on a slot game area are rearranged. The slot machine has slot game areas which include a slot game area provided with mechanical reels and a slot game area provided with a liquid crystal display. The method comprises: (a) executing the slot game on each of the slot game areas, and (b) exposing the mechanical reels for executing the slot game on the slot game area provided with the mechanical reels.

According to the fifth aspect of the present invention, the slot game is executed on the slot game area provided with the mechanical reels after the mechanical reels which has been hidden are exposed.

Therefore, it is possible to provide a player with an expectation for the slot game with the mechanical reels by a presentation of exposing the mechanical reels. Further, it is possible to produce a superior effect to enhance entertaining feature.

A sixth aspect of the present invention provides a playing method of a slot machine for playing a slot game. The slot game is a game in which symbols had been displayed on a slot game area are rearranged. The slot machine has slot game areas which include a slot game area provided with mechanical reels and a slot game area provided with a liquid crystal display. The method comprises: (a) executing the slot game on the slot game area provided with the liquid crystal display panel, and (b) exposing the mechanical reels for executing the slot game on the slot game area provided with the mechanical reels when the slot game executed in (a) has brought an outcome in which a prescribed condition has been met.

According to the sixth aspect of the present invention, the slot game is executed on the slot game area provided with the mechanical reels after the mechanical reels which has been hidden are exposed. Note that, the slot game is executed on the slot game area provided with the mechanical reels only when a prescribed condition has been met in the slot game on the slot game area provided with the liquid crystal display panel.

Therefore, it is possible to provide a player with an expectation for the outcome in which the prescribed condition has been met in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the mechanical reels are exposed in (b) when the slot game executed in (a) on any one of the plural slot game areas has brought the outcome.

According to this preferable configuration, the slot game is executed on the slot game area provided with the mechanical reels when the slot game executed on any one of the slot game areas has brought the outcome. The mechanical reels which has been hidden is exposed preliminarily before the slot game is executed. Therefore, a possibility of the slot game by the mechanical reels is raised.

Therefore, it is possible to provide a high expectation for the slot game on the slot game area provided with the mechanical reels by a presentation of exposing the mechanical reels.

A seventh aspect of the present invention provides a playing method of a slot machine for playing a slot game. The slot game is a game in which symbols had been displayed on a slot game area are rearranged. The slot machine has slot game areas which include a slot game area provided with mechanical reels and a slot game area provided with a liquid crystal display. The method comprises: (a) executing the slot game on the slot game area provided with the liquid crystal display panel, and (b) exposing the mechanical reels for executing the slot game on the slot game area provided with the mechanical reels when a winning combination has been achieved in the slot game executed in (a).

According to the seventh aspect of the present invention, the slot game is executed on the slot game area provided with the mechanical reels after the mechanical reels which has been hidden are exposed. Note that, the slot game is executed on the slot game area provided with the mechanical reels only when a winning combination has been achieved in the slot game on the slot game area provided with the liquid crystal display panel.

Therefore, it is possible to provide a player with an expectation for an achievement of a winning combination in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the mechanical reels are exposed in (b) when the slot game executed in (a) on any one of the plural slot game areas has brought the outcome.

According to this preferable configuration, the slot game is executed on the slot game area provided with the mechanical reels when a winning combination has been achieved in the slot game on any one of the slot game areas provided with the liquid crystal display panel. The mechanical reels which has been hidden is exposed preliminarily before the slot game is executed. Therefore, a possibility of the slot game by the mechanical reels is raised.

Therefore, it is possible to provide a high expectation for the slot game on the slot game area provided with the mechanical reels by a presentation of exposing the mechanical reels.

An eighth aspect of the present invention provides a playing method of a slot machine for playing a slot game. The slot game is a game in which symbols had been displayed on a slot game area are rearranged. The slot machine has slot game areas which include a slot game area provided with mechanical reels and a slot game area provided with a liquid crystal display. The method comprises: (a) executing the slot game on the slot game area provided with the liquid crystal display panel, and (b) exposing the mechanical reels for executing the slot game on the slot game area provided with the mechanical reels when a specific winning combination has been achieved among plural kinds of winning combinations in the slot game executed in (a).

According to the eighth aspect of the present invention, the slot game is executed on the slot game area provided with the mechanical reels after the mechanical reels which has been hidden are exposed. Note that, the slot game is executed on the slot game area provided with the mechanical reels only when a specific winning combination has been achieved among plural kinds of winning combinations in the slot game on the slot game area provided with the liquid crystal display panel.

Therefore, it is possible to provide a player with an expectation for an achievement of a specific winning combination among plural kinds of winning combinations in the slot game on the slot game area provided with the liquid crystal display panel. Further, it is possible to produce a superior effect to enhance entertaining feature.

It is preferable that the slot game areas include the slot game area provided with mechanical reels and plural slot game areas provided with the liquid crystal display panel, and the mechanical reels are exposed in (b) when a specific winning combination has been achieved among plural kinds of winning combinations in the slot game executed in (a) on any one of the plural slot game areas.

According to this preferable configuration, the slot game is executed on the slot game area provided with the mechanical reels when a specific winning combination has been achieved among plural kinds of winning combinations in the slot game on any one of the slot game areas provided with the liquid crystal display panel. The mechanical reels which has been hidden is exposed preliminarily before the slot game is executed. Therefore, a possibility of the slot game by the mechanical reels is raised.

Therefore, it is possible to provide a high expectation for the slot game on the slot game area provided with the mechanical reels by a presentation of exposing the mechanical reels.

### BRIEF DESCRIPTION OF THE DRAWINGS

FIG. 1 is an explanatory diagram showing eleven slot game areas displayed on a lower display (shutter of area A1 is opened) in first and second embodiments of a slot machine of the present invention;

FIG. 2 is an explanatory diagram showing eleven slot game areas displayed on a lower display (shutter of area A1 is closed) in first and second embodiments of a slot machine of the present invention;

FIG. 3 is a perspective view of the slot machine (shutter of area A1 is opened) of the first embodiment of the present invention;

FIG. 4 is a perspective view of the slot machine of (shutter of area A1 is closed) the first embodiment of the present invention;

FIG. 5 is a backside perspective view of an LCD panel in the slot machine of the first embodiment;

FIG. 6 is front side exploded perspective view of the LCD panel;

FIG. 7 is a block diagram showing a control circuit of the slot machine of the first embodiment;

FIG. 8 is a flowchart showing a processing procedure (slot game execution processing) in the slot machine of the first embodiment;

FIG. 9 is a flowchart showing a processing procedure (execution processing for slot games on areas A2 to A11) in the slot machine of the first embodiment;

FIG. 10 is a flowchart showing a processing procedure (bonus game starting processing) in the slot machine of the first embodiment;

FIG. 11 is a flowchart showing a processing procedure (bonus game execution processing) in the slot machine of the first embodiment;

FIG. 12 is a flowchart showing a processing procedure (bet processing) in the slot machine of the first embodiment;

FIG. 13 is a flowchart showing a processing procedure (bet processing [alternate example]) in the slot machine of the first embodiment;

FIG. 14 is a flowchart showing a processing procedure (execution processing for slot game on area A1) in the slot machine of the first embodiment;

FIG. 15 is an explanatory diagram showing a central slot game area in the slot machine of the first embodiment;

FIG. 16 is an explanatory diagram showing one of the slot game areas other than the central slot game area;

FIG. 17 is an explanatory diagram showing paylines on the slot game area;

FIG. 18 is an explanatory diagram showing a payout table for slot games;

FIG. 19 is an explanatory diagram showing the slot game areas displayed on the LCD panel;

FIG. 20 is an explanatory diagram showing the slot game areas displayed on the LCD panel;

FIG. 21 is an explanatory diagram showing a relationship between bet amounts and bet areas in the slot machine of the first embodiment;

FIG. 22 is a perspective view of the slot machine of the second embodiment of the present invention;

FIG. 23 is a block diagram showing a control circuit of the slot machine of the second embodiment;

FIG. 24 is a flowchart showing a processing procedure (slot game execution processing) in the slot machine of the second embodiment;

FIG. 25 is a perspective view of the slot machine of the third embodiment of the present invention;

FIG. 26 is a block diagram showing a control circuit of the slot machine of the third embodiment;

FIG. 27 is an explanatory diagram showing a closed shutter unit of the slot machine of the fourth embodiment;

FIG. 28 is an explanatory diagram showing an opened shutter unit of the slot machine of the fourth embodiment;

FIG. 29 is a block diagram showing a control circuit of the slot machine of the fourth embodiment; and

FIG. 30 is a flowchart showing a processing procedure (execution processing for slot game on area A1) in the slot machine of the fourth embodiment.

### DETAILED DESCRIPTION OF THE EMBODIMENT

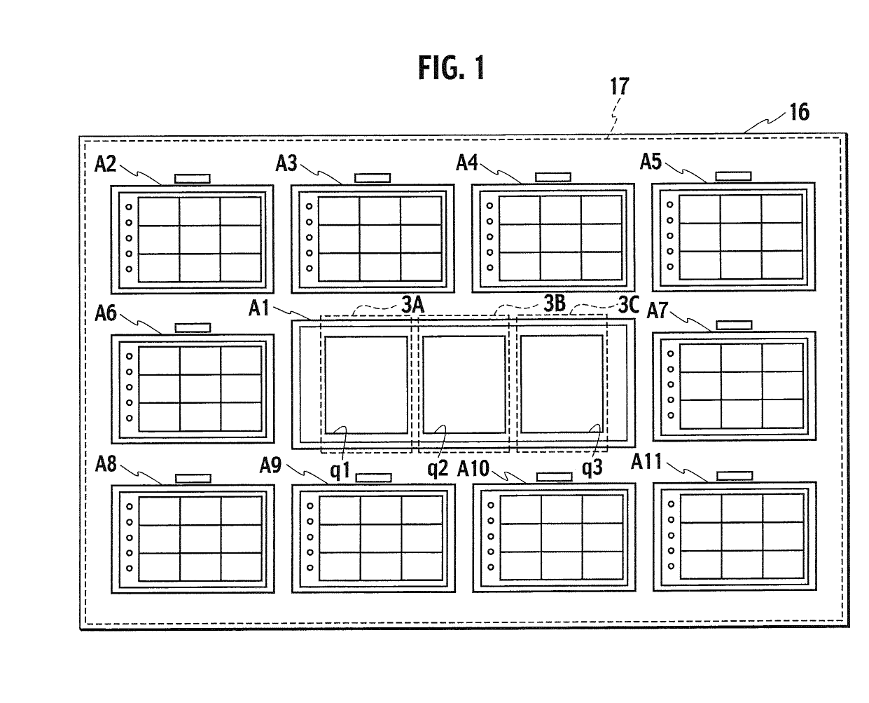

Characteristics of a first embodiment of the present invention will be described below with reference to FIG. 1 to FIG. 4. As shown in FIG. 1, eleven slot game areas A1 to A11 are provided on a lower display 16 (corresponding to a “display” in claims). A slot game is executed in each of the slot game areas A1 to A11.

The slot game areas A1 to A11 include one large slot game area A1 (corresponding to a “slot game area provided with mechanical reels” in claims) in the center and ten small slot game areas A2 to A11 (respectively corresponding to a “slot game area provided with a liquid crystal display” in claims) arranged therearound.

Display areas of three rows by three columns are provided in the respective slot game areas A2 to A11 except the central slot game area A1. A credit(s) (corresponding to the “gaming media”) is bet by an insertion of a medal(s) or pressing of a bet switch 25. Symbols displayed (arranged) in the display areas are scrolled when a start switch 27 has been pressed and then the symbols stop (rearranged) in each of the display areas. In this manner, the slot game is executed in each of the slot game areas A2 to A11.

In the slot game executed in each of the slot game areas A2 to A11 except the central slot game area A1, up to three credits can be bet and the number of activated paylines increases as a bet amount increases in each slot game.

On the other hand, display areas of one row by three columns are provided on the central slot game area A1. On the slot game area A1, the symbols displayed (arranged) in each of the display areas are scrolled when a prescribed condition has been met in the slot games executed on the slot game areas A2 to A11 and then the symbols stop (rearranged) in each of the display areas. In this manner, the slot game is executed on the slot game area A1.

In addition, since the display areas on the central slot game area A1 is configured with one row by three columns, the central slot game area A1 has only one payline. As a result, only one credit can be bet on the slot game executed on the central slot game area A1.

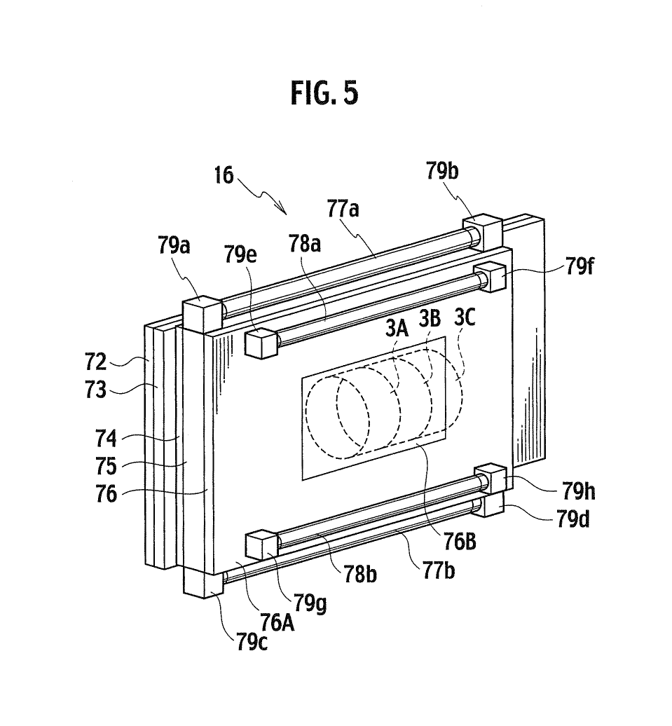

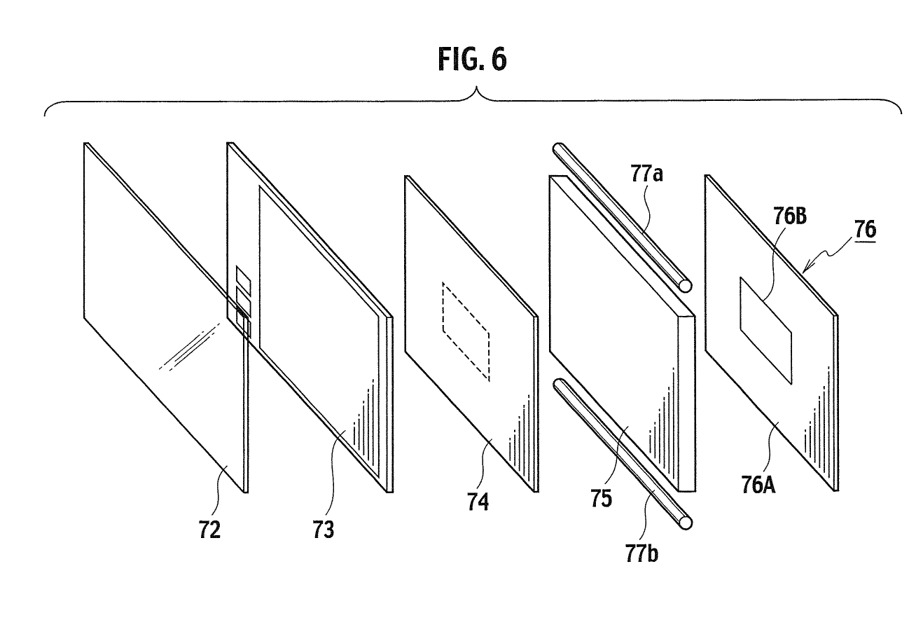

The surrounding ten slot game areas A2 to A11 are displayed on an LCD panel 17 provided in the lower display 16. The configuration of the LCD panel 17 will be described later with reference to FIG. 5 and FIG. 6.

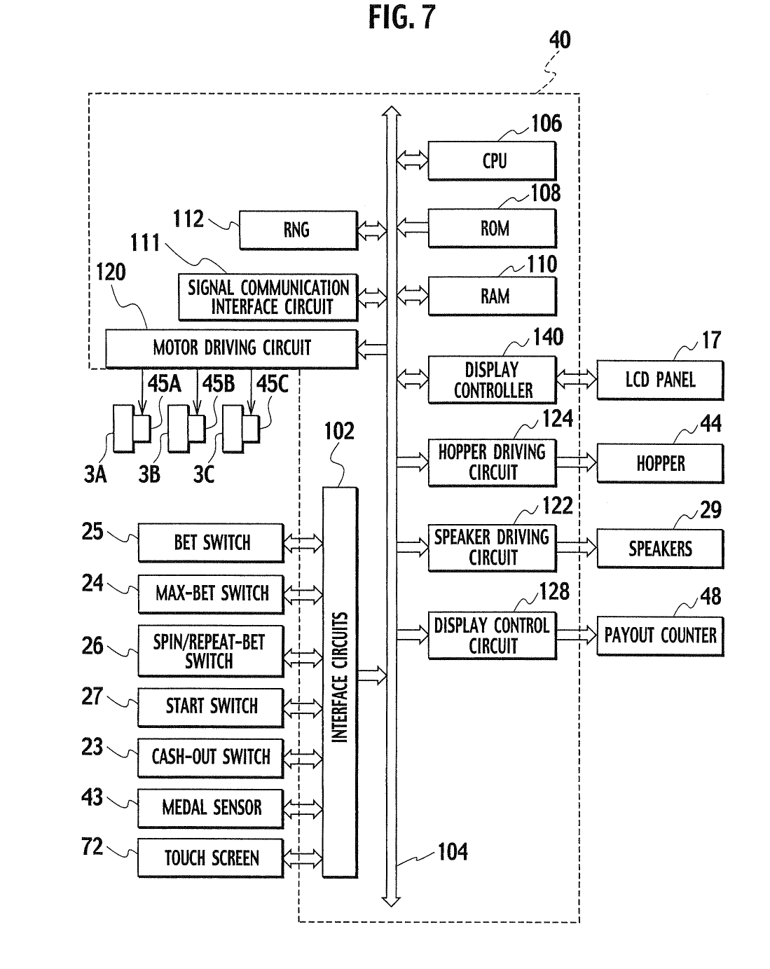

The central slot game area A1 is displayed by three mechanical reels 3A to 3C disposed behind the center area of the LCD panel 17. Each of the reels 3A to 3C is spun by each of stepping motors 45A to 45C (see FIG. 7), respectively. A plurality of symbols is disposed on a peripheral surface of each of the reels 3A to 3C with at some intervals. On the center area of the LCD panel 17 opposing each of the reels 3A to 3C, transmissive display areas q1 to q3 are displayed to make each of the reels 3A to 3C recognized visually. In actuality, each of the display areas q1 to q3 is changed to a transmissive (colorless) state by the control of the LCD panel 17.

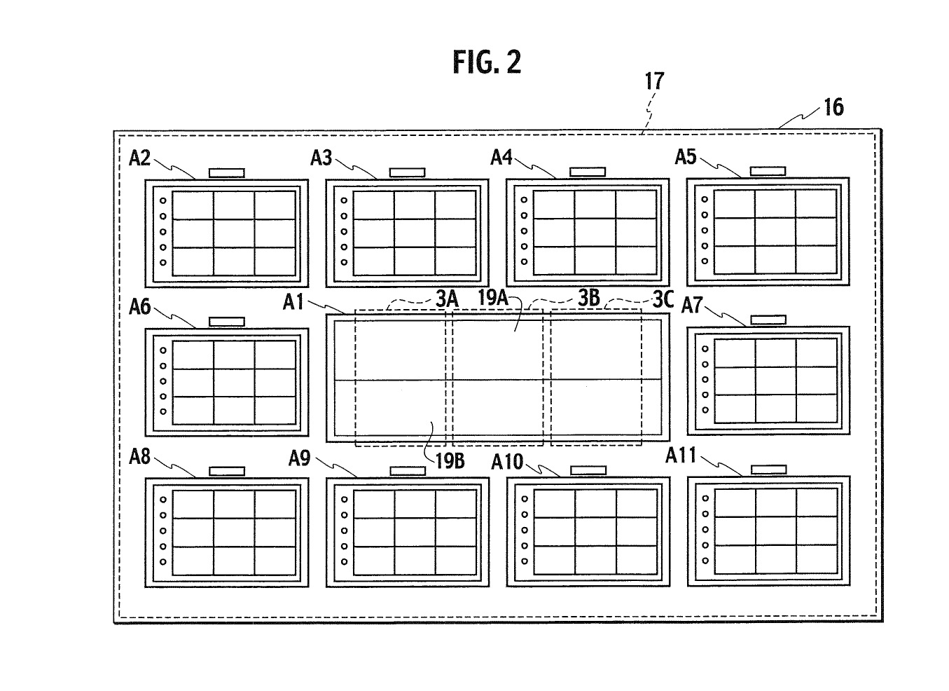

The closed video shutter 19 (see FIG. 2) is displayed on the center area of the LCD panel 17 to hide the reels 3A to 3C when the slot game is not executed in the central slot game area A1. The video shutter 19 includes a pair of upper and lower shutter doors 19A, 19B and is displayed on the display areas q1 to q3 of the LCD panel 17 opposing the reels 3A to 3C.

The video shutter 19 is opened when the slot game is executed on the central slot game area A1. The shutter doors 19A, 19B are opened in the vertical direction on the central slot game area A1 when the video shutter 19 is opened. The video shutter 19 is not displayed any longer on the center area of the LCD panel 17 as shown in FIG. 1 after the video shutter 19 has been opened. The transmissive display areas q1 to q3 are displayed on the center area of the LCD panel 17 in place of the video shutter 19 to make the reels 3A to 3C recognized visually. In this manner, the reels 3A to 3C are exposed in the central slot game area A1 to allow a player to recognize them visually through the transmissive display areas q1 to q3. In detail, it is possible for the player to only recognize the partial peripheral surface of each of the reels 3A to 3C opposing the slot game area A1.

As obvious from the above description, in the present embodiment, the shutter in claims is constituted by the LCD panel 17 (corresponding to a “display device” in claims) displaying the video shutter 19.

The lower display 16 on which the slot game areas A1 to A11 are displayed is arranged in a center of a front face of a slot machine 10. In the slot machine 10, a bet can be placed on each of the slot game areas A1 to A11 when a medal(s) is inserted into a medal insertion slot 21 provided below the lower display 16 (or a bet maybe placed with internally stored credits by the pressing of the bet switch 25). The player can select (activate) the slot game areas A1 to A11 to be bet (activated) arbitrarily. In other words, the player can select (activate the slot game areas A1 to A11 on which games are executed with a bet placed. For example, it is possible for the player to activate each of the slot game areas A1 to A11 by touching it. The operation of touching the slot game areas A1 to A11 can be detected by a touch screen 72 provided on a surface of the LCD panel 17.

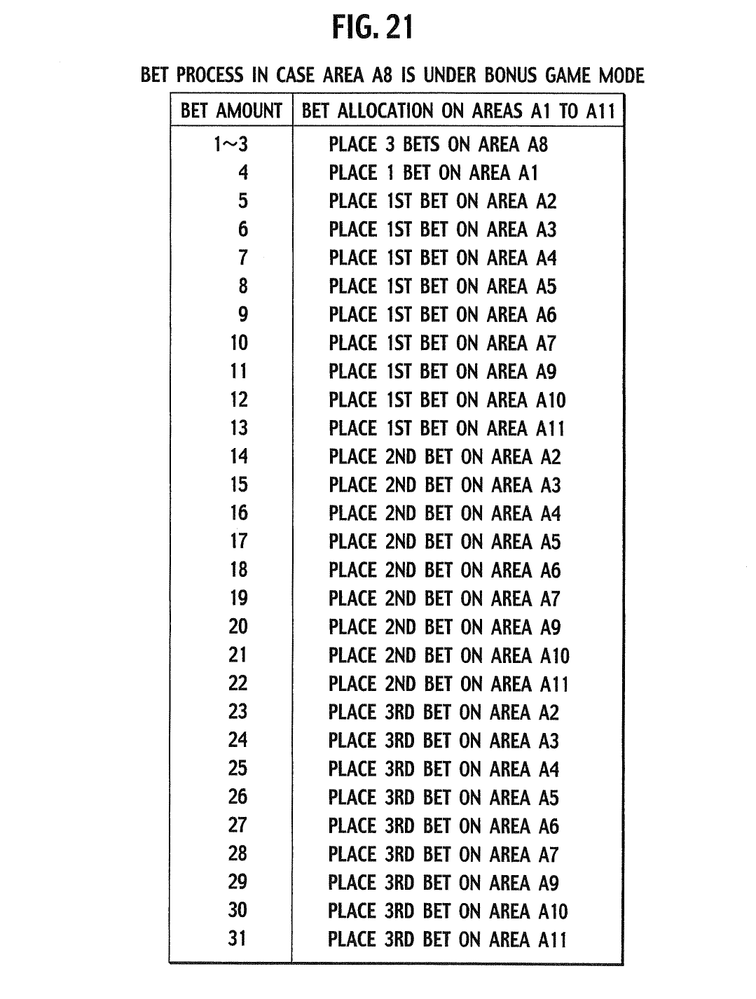

For example, one bet is placed on the slot game area A1 when the player inserts one medal into the medal insertion slot 21 after touching the slot game area A1. And then, one more bet is placed on the slot game area A1 when the second medal is inserted further. However, a bet is placed preferentially on the slot game areas A2 to A11 on which a bonus game is being executed. This will be further described in detail later with reference to FIG. 21. In addition, as described above, only one bet can be placed on the central slot game area A1.

It may also be possible that the player previously selects (activates) a slot game area(s) by touching the game area(s) and then places a bet(s) on the activated slot game area(s) randomly by inserting a medal(s).

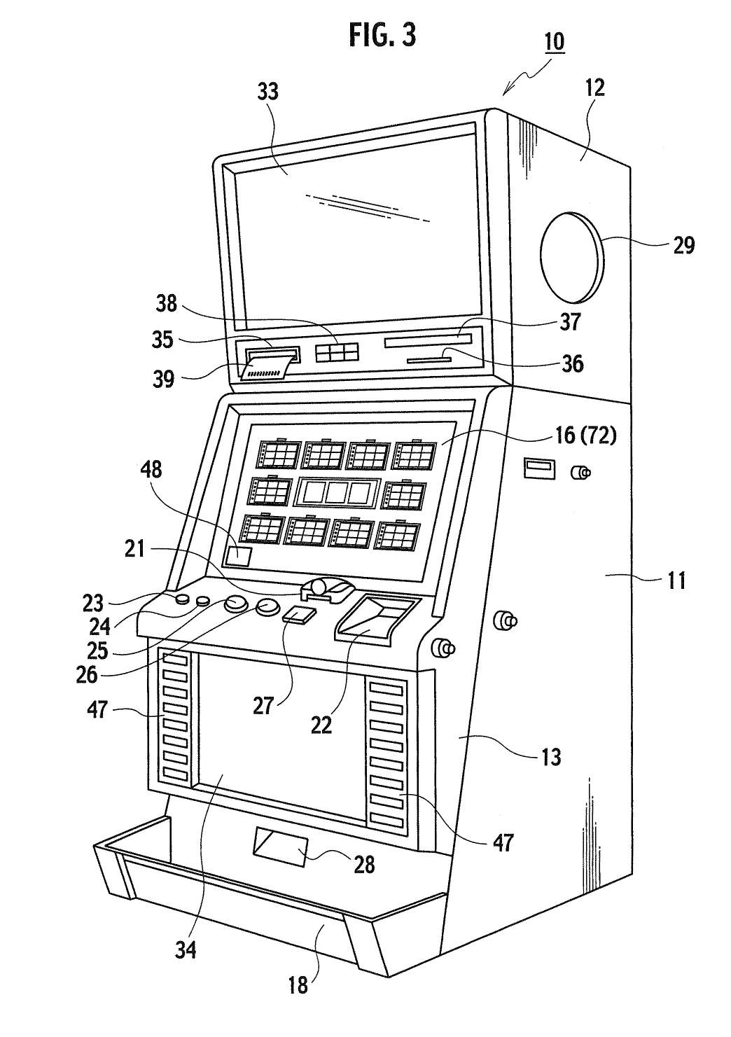

After a bet(s) is placed on the slot game(s) and the slot game(s) are executed on the lower display 16 shown in FIG. 1 and FIG. 3, a payout (payout of a medal(s), or addition of credits) is provided according to a bet amount and a winning combination when the winning combination is achieved on the payline in the slot game on each of activated slot game areas A2 to A11 except the central slot game area A1.

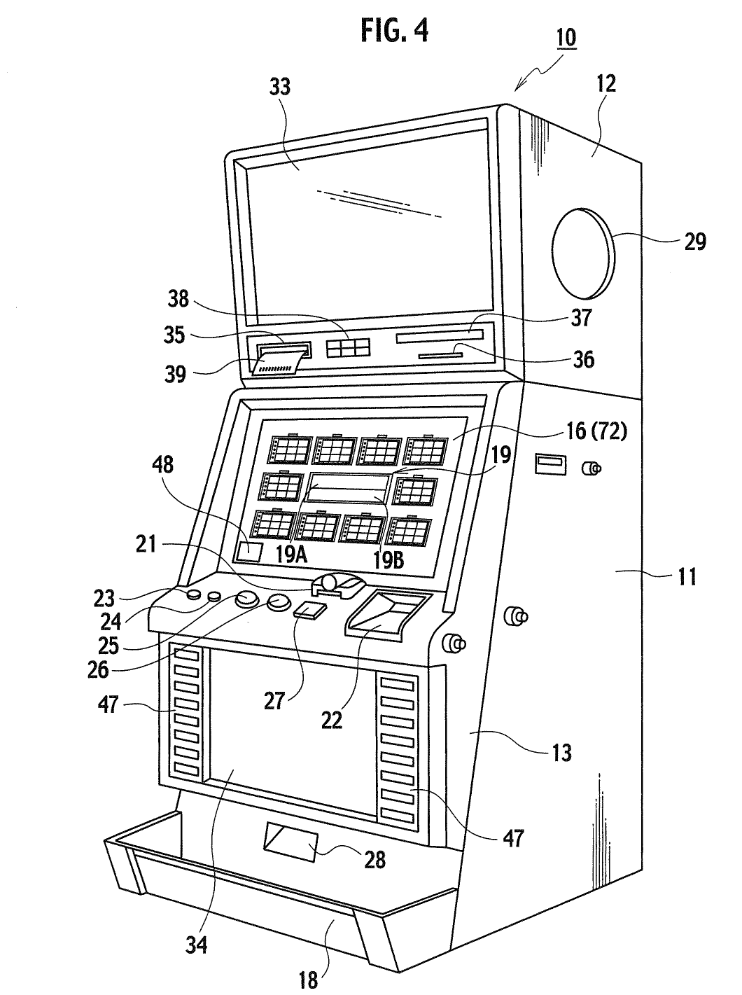

The slot game is executed on the central slot game area A1 of the lower display 16 shown in FIG. 2 and FIG. 4 only when any of the slot games executed on the slot game areas A2 to A11 has met a prescribed condition. The prescribed condition in the present embodiment is that a winning combination is achieved on the activated payline in any of the slot games on the slot game areas A2 to A11.

A medal (s) according to the winning combination is cashed out or a credit(s) is added as a result of the winning combination in the slot game on the central slot game area A1 only when a bet has been placed on the central slot game area A1 preliminarily.

In the present embodiment, a bet(s) is placed on the slot game areas A1 to A11 by the insertion of a medal(s), however, a bet may be placed using a coin, bill, bar coded ticket, etc. In addition, in the present embodiment, the symbols are scrolled and then stopped again in the slot game on each of the slot game areas A2 to A11 except the central slot game area A1. However, the slot game on each of the slot game areas A2 to A11 is not limited to that in which the symbols are scrolled. For example, the symbols may be successively switched over in each of the display areas and then stopped.

Further, in the present embodiment, a maximum bet amount is set to three on the slot game areas A2 to A11 except the central slot game area A1. However, the maximum bet amount is not limited to this. If two or more rows of the display areas are provided on the central slot game area A1, the number of activated paylines can be increased according to a bet amount.

In the present embodiment, a bet can be placed on the central slot game area A1. However, it may be possible that a bet cannot be placed on the central slot game area A1. In this case, the slot game is executed on the central slot game area A1 just as an entertaining effect even when any of the slot games on the slot game areas A2 to A11 has met the prescribed condition. Therefore, a payout is not awarded to the player even if a winning combination is achieved in the slot game on the central slot game area A1.

However, in the present embodiment described in detail hereinafter, a bet can be placed on the central slot game area A1

Next, a configuration of the slot machine 10 of the present embodiment will be described. The slot machine 10 includes a cabinet 11 and a top box 12 provided on top of the cabinet 11, as shown in FIG. 3. The cabinet 11 has a main door 13. An upper display 33 is provided on the front of the top box 12 facing the player. The lower display 16 is disposed on the front of the cabinet 11 facing the player. Various component devices are disposed within the cabinet 11, such as a controller 40 (see FIG. 7) for electrically controlling the slot machine 10 and a hopper 44 (see FIG. 7) for controlling the insertion, pooling, and payout of medals.

In the present embodiment, medals are used for gaming media at game play. However, gaming media is not limited to medals only. For example, coins, tokens, electronic money, or other equivalent electronic value information may be also used as gaming media.

The main door 13 is attached to the cabinet 11 so that it can be opened and closed. The lower display 16 is disposed on an upper portion of the main door 13. As will be described in detail later, the eleven slot game areas A1 to A11 are provided on the lower display 16 and independent slot games are executed on the slot game areas A1 to A11, respectively. In the present embodiment, the number of slot game areas is eleven. However, two or more slot game areas including at least one slot game area constituted by mechanical reels and at least one slot game area constituted by an LCD may be provided.

Three display areas with one row by three columns are provided on the central slot game area A1. Nine display areas with three rows by three columns are provided on each of the slot game areas A2 to A11. various kinds of symbols can be displayed in each of the display areas. In other words, symbols displayed (arranged) in each of the display areas are scrolled when a slot game has been started and then stopped (rearranged) after a predetermined time has elapsed. Then, a payout is awarded to a player according to a symbol combination that stops in the display areas on activated slot game areas A1 to A11.

The touch screen 72 is provided on a surface of the lower display 16. The touch screen 72 is partitioned into areas in a matrix. Some of the partitioned areas correspond to the ten slot game areas A2 to A11 displayed and the central slot game area A1 on the LCD panel 17. The central slot game area A1 can be visually recognized through a central area of the LCD panel 17. In other words, a touched position can be detected by the touch screen 72 when the player touches each of the slot game areas A1 to A11.

A payout counter 48 for displaying a payout amount is provided in a bottom left area of the lower display 16 (LCD panel 17).

The medal insertion slot 21 and a bill validator 22 are disposed below the lower display 16. The bill validator 22 validates bills and accepts valid ones. Various operational switches are disposed nearby the medal insertion slot 21 and the bill validator 22.

A cash-out switch 23, a max-bet switch 24, a bet switch 25, a spin/repeat-bet switch 26, and the start switch 27 are provided as the operational switches.

The bet switch 25 is a switch for determining a bet amount on each slot game on the slot game areas A1 to A11. As will be described later, each time the bet switch 25 is pressed, one bet is placed on a predetermined slot game area. The slot game area on which a bet has been placed is activated and a payout is provided to the player when a winning symbol combination has been achieved on an activated payline in the slot game.

The spin/repeat-bet switch 26 is a switch for placing a bet again without changing a bet amount placed by the bet switch 25 (and the max-bet switch 24) on the previous game on each of the slot game areas A1 to A11 and starting a slot game on each of the slot game areas A2 to A11.

The start switch 27 is a switch for starting a slot game on each of the slot game areas A2 to A11 after bets have been placed on desired slot game areas. A slot game on each of the slot game areas A2 to A11 is started after a medal(s) was inserted into the medal insertion slot 21 or a bet(s) was placed by the bet switch 25 and the start switch 27 has been pressed.

The cash-out switch 23 is a switch for cashing out awarded medals (internally stored credits). The medals are cashed out from a medal cash-out chute 28 opened in the front lower part of the main door 13 and pooled on a medal tray 18.

The max-bet switch 24 is a switch for betting the maximum bet amount (e.g., thirty-one credits) that can be placed on a single game play by one pressing.

A foot display 34 is disposed on the lower front of the main door 13. Various images relating to the game of the slot machine 10 (such as characters of the slot machine 10) are displayed on the foot display 34.

Lamps 47 are provided on both sides of the foot display 34 and illuminate in a preset illuminating pattern. The medal cash-out chute 28 is provided below the foot display 34.

The upper LCD 33 is disposed on the front of the top box 12. The upper display 33 has a display panel and displays a payout table indicating each payout amount for each symbol combination etc.

Speakers 29 are provided on the top box 12. A ticket printer 35, a card reader 36, a data display 37, and a keypad 38 are disposed below the upper display 33. The ticket printer 35 prints out a ticket 39 including data such as a credit amount, time and date, identification number of the slot machine 10 printed thereon as a bar code.

The player can play a game at another slot machine by using the bar-coded ticket 39, and exchange the bar-coded ticket 39 for bills at a predetermined site in an amusement facility (e.g., a cashier in the casino).

A smart card can be inserted into the card reader 36 and the card reader 36 reads data from the inserted smart card and writes data onto the smart card. The smart card is carried by the player and stores the player's identification data and gaming history data of the games played by the player.

FIG. 7 is a block diagram illustrating the electric configuration of the controller 40 and various components connected to the controller 40, which are provided within the slot machine 10 of the present embodiment. The controller 40 of the slot machine 10 is a microcomputer and includes interface circuits 102, an input/output (I/O) bus 104, a CPU 106, a ROM 108, a RAM 110, a signal communication interface (I/F) circuit 111, a random number generator (RNG) 112, a motor drive circuit 120, a speaker drive circuit 122, a hopper drive circuit 124, a display control circuit 128, and a display controller 140.

The interface circuits 102 are connected to the I/O bus 104. The I/O bus 104 inputs/outputs data signals and address signals to/from the CPU 106.

The start switch 27 is connected to the interface circuits 102. A start signal output from the start switch 27 is transmitted to the CPU 106 via the I/O bus 104, after having been converted into a predetermined signal by the interface circuits 102.

The bet switch 25, the max-bet switch 24, the spin/repeat-bet switch 26, and the cash-out switch 23 are connected to the interface circuits 102. A switching signal output from each of the switches 23 to 26 is transmitted to the CPU 106 via the I/O bus 104, after having been converted into a predetermined signal by the interface circuits 102.

A medal sensor 43 is connected to the interface circuits 102. The medal sensor 43 detects a medal(s), which has been inserted into the medal insertion slot 21. The medal sensor 43 is provided inside the medal insertion slot 21. The detection signal output from the medal sensor 43 is transmitted to the CPU 106 via the I/O bus 104, after having been converted into a predetermined signal by the interface circuits 102.

The touch screen 72 described above is connected to the interface circuits 102. The touch screen 72 detects the touch operation onto the slot game areas A1 to A11 displayed on the lower display 16 by a player. The touch screen 72 is provided on the surface of the LCD panel 17. A position signal output from the touch screen 72 is transmitted to the CPU 106 via the I/O bus 104, after having been converted into a predetermined signal by the interface circuits 102.

The ROM 108 storing system programs and the RAM 110 storing various data are connected to the I/O bus 104. The RNG 112, the signal communication I/F circuit 111, the motor drive circuit 120, the display controller 140, the hopper drive circuit 124, the speaker drive circuit 122, and the display control circuit 128 are connected to the I/O bus 104.

The CPU 106, triggered by receiving the start signal from the start switch 27, reads a game execution program among the system programs stored in the ROM 108 and executes a game. The game execution program is a program for executing the slot game in each of the slot game areas A1 to A11 on the lower display 16 using the motor drive circuit 120 and the display controller 140.

In other words, the game execution program is programmed so as to execute a slot game in which symbols are rearranged after scrolling in each of the slot game areas A1 to A11 and a payout is provided when a winning combination is achieved on an activated payline.

The signal communication I/F circuit 111, which is connected to a hall server etc., transmits gaming history data etc. of the slot machine 10 to the hall server. The signal communication I/F circuit 111 receives various data transmitted from the hall server.

The RNG 112 generates a random number for determining whether or not to achieve a winning combination in the slot game on each of the slot game areas A1 to A11.

The display control circuit 128 controls displaying a payout amount on the payout counter 48 provided at the lower left area of the lower display 16 (LCD panel 17).

The speaker drive circuit 122 outputs sound data to the speakers 29. In other words, the CPU 106 reads the sound data stored in the ROM 108 and transmits the sound data to the speaker drive circuit 122 via the I/O bus 104. In this manner, predetermined sound effects are generated via the speakers 29.

The hopper drive circuit 124 outputs a cash-out signal to the hopper 44 when providing a cash-out. In other words, the CPU 106 outputs a drive signal to the hopper drive circuit 124 via the I/O bus 104 when receiving the cash-out signal from the cash-out switch 23. As a result, the hopper 44 cashes out medals equivalent to the credits stored at that time in a predetermined memory area of the RAM 110.

The motor drive circuit 120 controls the execution of the slot game by the reels 3A to 3C on the central slot game area A1 of the lower display 16. The motor drive circuit 120 is configured by including a reel CPU, a reel ROM, and a reel RAM internally. In detail, the CPU 106 generates a command signal relating to a symbol display according to status and an outcome of the slot game on the slot game area A1 and outputs the command signal to the motor drive circuit 120 via the I/O bus 104. Upon receipt of the command signal, the motor drive circuit 120 generates drive signals for the stepping motors 45A to 45C, which spins or stops each of the reels 3A to 3C based on the command signal. And then, the motor drive circuit 120 outputs the drive signals to the stepping motors 45A to 45C, respectively. In this manner, the slot game is executed (predetermined images are displayed) on the slot game area A1.

The display controller 140 controls the execution of the slot game on each of the slot game areas A2 to A11 around the slot game area A1. In detail, the CPU 106 generates an image display signal according to status and an outcome of the slot game on each of the slot game areas A2 to A11 and outputs the image display signal to the display controller 140 via the I/O bus 104. Upon receipt of the image display signal, the display controller 140 generates a drive signal of the LCD panel 17 based on the image display signal. And then, the display controller 140 outputs the drive signal to the LCD panel 17. In this manner, the slot game is executed (predetermined images are displayed) on each of the slot game areas A2 to A11.

The display controller 140 controls displaying of the video shutter 19 on the central slot game area A1. In other words, the CPU 106 generates an image display signal in accordance with a status or an outcome of the slot game on the slot game area A1 and outputs the image display signal to the display controller 140 via the I/O bus 104. Upon receipt of the image display signal, the display controller 140 generates a drive signal of the LCD panel 17 based on the image display signal. And then, the display controller 140 outputs the image display signal to the LCD panel 17. in this manner, the video shutter 19 is displayed on the slot game area A1.

FIG. 5 is a perspective view when the LCD panel 17 is viewed from behind. FIG. 6 is an exploded perspective view when viewed from the front. Some parts shown in FIG. 5 are omitted (not shown) in FIG. 6.

The LCD panel 17 has a shape and size corresponding to the lower display 16. As shown in FIG. 5 and FIG. 6, the LCD panel 17 is constituted by overlapping a liquid crystal unit 74, a light guide plate 75, and a reflective film 76 in the order from the front side of the slot machine 10.

The liquid crystal unit 74 is constituted by filling liquid crystal between a transparent substrate, such as a glass plate on which a thin film transistor layer is formed, and another transparent substrate in opposition thereto. The liquid crystal unit 74 changes colorless in an inactive state, in which no image is displayed. In the inactive state, the transmitted light can be visually recognized from the outside. The central area of the liquid crystal unit 74 is set to the inactive (transmissive) state during an execution of the slot game on the central slot game area in order for a player to visually recognize the reels 3A to 3C.

The light guide plate 75 guides light from fluorescent tubes 77a, 77b to the inside of the liquid crystal unit 74 to illuminate the liquid crystal unit 74 from the backside. Specifically, the light guide plate 75 is a transparent member having a thickness of about 2 cm and made of acryl resin etc. The light guide plate 75 is made of a material having light guiding feature. The fluorescent tubes 77a, 77b are attached on upper and lower ends of the light guide plate 75 by lamp holders 79a to 79d.

The reflective film 76 has a transparent film as a substrate, such as a polyester film etc. The reflective film 76 has a non-reflective area 76B and a reflective area 76A therearound. The shape, position, and size of the non-reflective area 76B are the same as those of the central slot game area A1. The non-reflective area 76B is a light transmissive plane made of the substrate. The reflective area 76A is made by depositing a thin aluminum or silver layer on the substrate.

The reflective area 76A of the reflective film 76 partially reflects light introduced into the inside of the light guide plate 75 from the upper and lower ends thereof. And then, the reflective area 76A outputs the light frontward. The reflective area 76A prevents light from leaking backward and effectively outputs the light frontward.

Fluorescent tubes 78a, 78b are disposed behind the reflective film 76 with lamp holders 79e to 79h. The fluorescent tubes 78a, 78b illuminate the periphery of the reels 3A to 3C from above and beneath.

An outer plate 73 is disposed in front of the liquid crystal unit 74. The touch screen 72 is arranged on the surface of the outer plate 73. The touch screen 72 detects player's touch operations etc. The touch screen 72 is made of a transmissive member. The outer plate 73 is made of a transmissive member and images, such as patterns, characters, etc., are drawn on its surface. The images are drawn on the areas outside the slot game areas A1 to A11. The player can see the images drawn on the areas outside the areas A1 to A11 when playing with the slot machine 10. The outer plate 73 may be omissible.

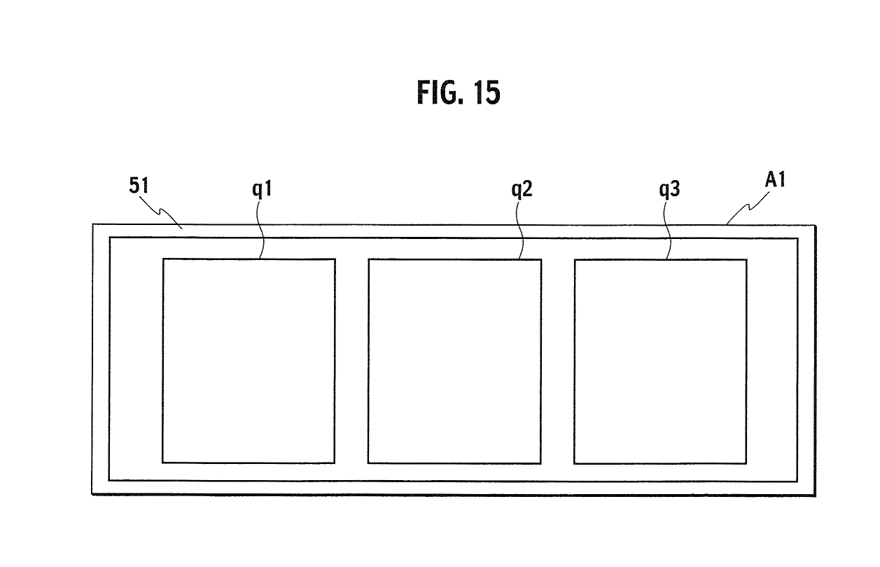

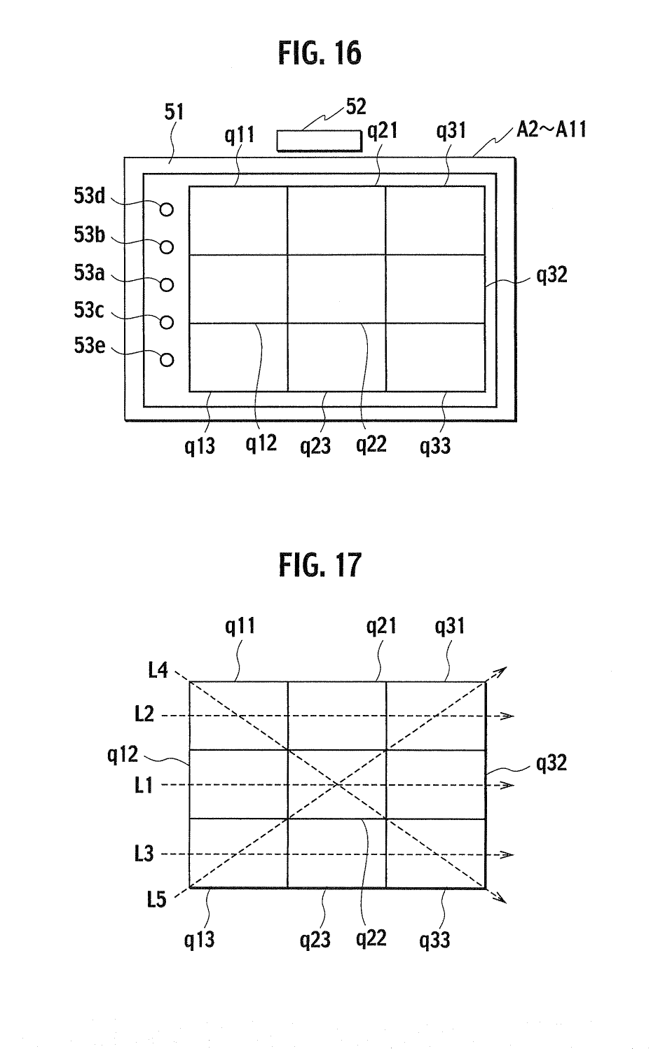

Next, images displayed on the slot game areas A1 to A11 are explained with reference to FIG. 15 and FIG. 16. FIG. 15 is a display example of the central slot game area A1 and FIG. 16 is a display example of the slot game areas A2 to A11.

As shown in FIG. 15, three (one row by three column) display areas q1 to q3 are provided on the central slot game area A1. Symbols are scrolled by the reels 3A to 3C in each of the display areas q1 to q3 when the slot game is started.

Then, a payout is awarded according to a winning combination when the winning combination is achieved in the display areas q1 to q3 of the central slot game area A1.

As shown in FIG. 16, nine (three row by three column) display areas q11 to q33 are provided on each of the slot game areas A2 to A11. Symbols are scrolled in each of the columns of the display areas q11 to q33 on the LCD panel 17 when the slot game is started on each of the slot game areas A2 to A11.

Five LEDs 53a to 53e are provided on the left side of the display areas q11 to q33 of each of the slot game areas A2 to A11. The LEDs 53a to 53e notify the activated payline(s) on each of the slot game areas A2 to A11. As shown in FIG. 17, five paylines are prepared on the display areas q11 to q33. A horizontal line in the middle row is L1, a horizontal line in the upper row is L2, a horizontal line in the lower row is L3, a diagonal line going down to the right is L4, and a diagonal line going up to the right is L5.

The LEDs 53a to 53e light up according to a bet amount. In detail, only the LED 53a lights up when one credit is bet. The LEDs 53b, 53c, in addition to the LED 53a, light up when two credits are bet. The LEDs 53d, 53e, in addition to the LEDs 53a to 53c, light up when three credits are bet.

It is indicated that the line L1 has been activated, when the LED 53a lights up. In addition, it is indicated that the lines L2, L3 have been activated, respectively, when the LEDs 53b, 53c light up. Furthermore, it is indicated that the lines L4, L5 have been activated, respectively, when the LEDs 53d, 53e light up. As a result, only the line L1 is activated when one credit has been bet, the lines L1, L2, and L3 are activated when two credits have been bet, and all of the lines L1 to L5 are activated when three credits have been bet. Then, a payout is awarded according to a winning combination(s) when the winning combination(s) is achieved on the activated payline (s).

An activation indicating frame 51 is provided on each peripheral edge of the slot game areas A1 to A11. Each of the activation indicating frames 51 lights up on the LCD panel 17 for the activated slot game areas A1 to A11. The activation indicating frame 51 lights up on the slot game areas A1 to A11 on which at least one credit is bet. It is possible for a player to easily recognize the activated slot game area(s) by the activation indicating frame(s) 51.

A bonus game indicator 52 is provided above each of the slot game areas A2 to A11 except the central slot game area A1. The bonus game indicator 52 of each of the slot game areas A2 to A11 lights up on the LCD panel 17 during a bonus game (to be described later). It is possible for a player to easily recognize the slot game area(s) during the bonus game by the bonus game indicator(s) 52.

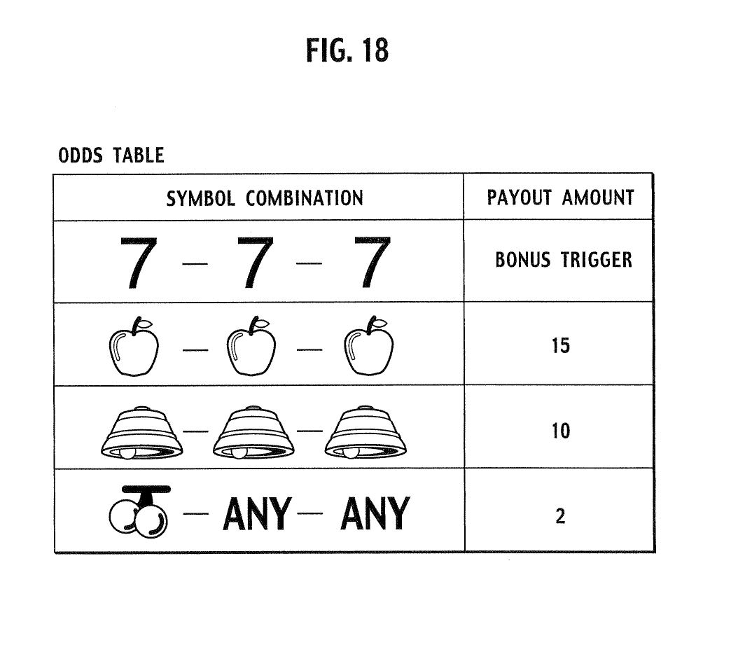

FIG. 18 shows winning combinations in the slot game. As shown in FIG. 18, the bonus game is started on the own slot game area when three 7's are rearranged on the activated payline, a 15-credit payout is awarded to the player when three APPLEs are rearranged, a 10-credit payout is awarded when three BELLs are rearranged, and a 2-credit payout is awarded when a “CHERRY” is rearranged on the leftmost of the activated payline.

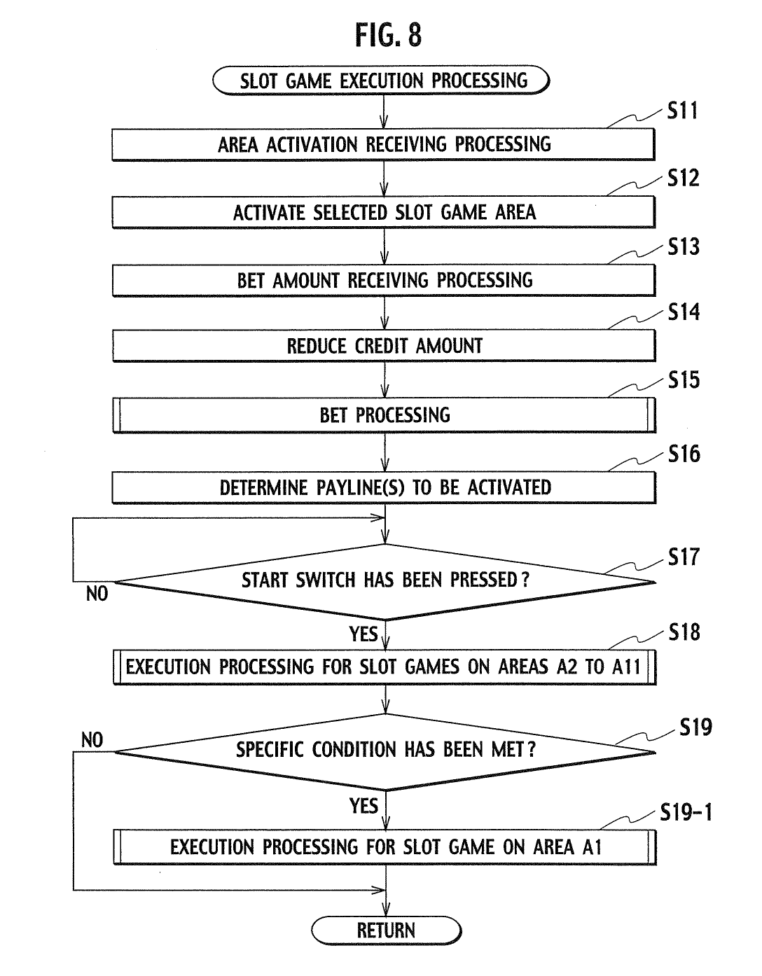

Next, an operation of the slot machine of the present embodiment is described with reference to flowcharts shown in FIG. 8 to FIG. 14. FIG. 8 is a flowchart showing slot game execution processing. The slot game execution processing is executed by the CPU 106 (FIG. 7) according to the game execution programs stored in the ROM 108.

First, the CPU 106 executes area activation receiving processing for receiving a selection for activating slot game areas A1 to A11 (step S11). In the area activation receiving processing, the slot game areas A1 to A11, which have been touched by the player to activate, are detected by the touch screen 72. Then, the CPU 106 activates the touched slot game areas A1 to A11 (step S12). The CPU 106 lights up the activation indicating frame 51 on the peripheral edge of the activated slot game area(s) to notify the player of the activated slot game area(s).

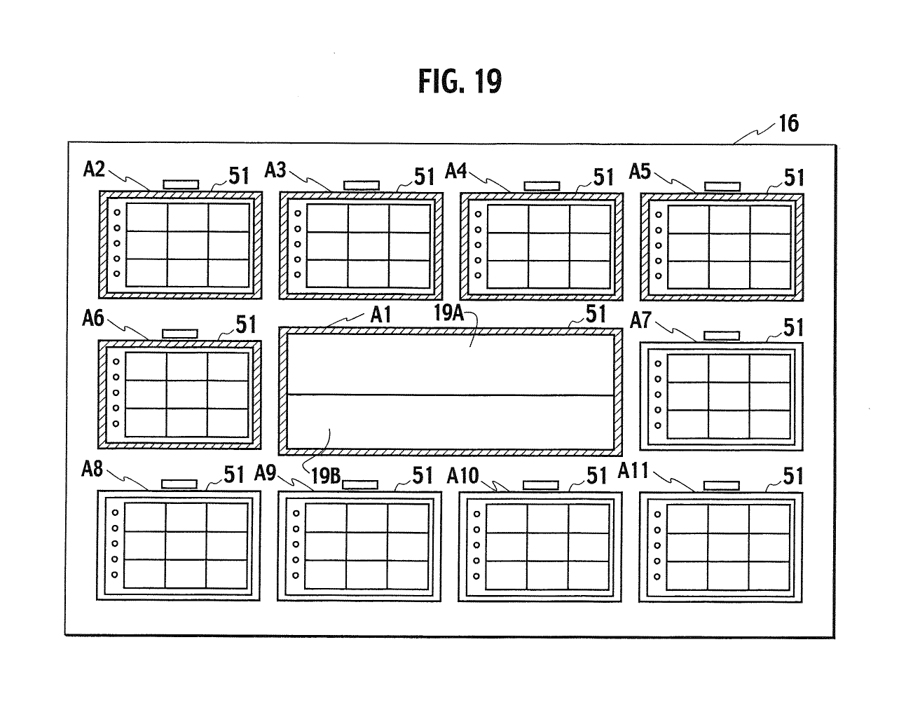

For example, when the slot game areas A1 to A6 has been activated, the activation indicating frames 51 of the activated slot game areas A1 to A6 are lit up and the activation indicating frames 51 of the non-activated slot game areas A7 to A11 are not lit up, as shown in FIG. 19.

Next, the CPU 106 executes bet amount receiving processing for receiving a total bet amount on the slot games on the activated slot game areas A1 to A11 (step S13). In the bet amount receiving processing, pressing of the bet switch 25 by the player is detected and the bet total amount is calculated. Then, the CPU 106 subtracts the bet amount having been input from an internally stored credit amount (step S14). For example, if the stored credit amount is 50 credits and a 30-credit bet amount is received, the stored credit amount will be 20 credits.

It is also possible to place a bet on each slot game on the activated slot game areas A1 to A11 by inserting a medal(s) into the medal insertion slot 21. In this case, the CPU 106 recognizes the number of inserted medals as a bet amount. In this case, it is not needed to execute subtraction from the stored credit amount in step S14.

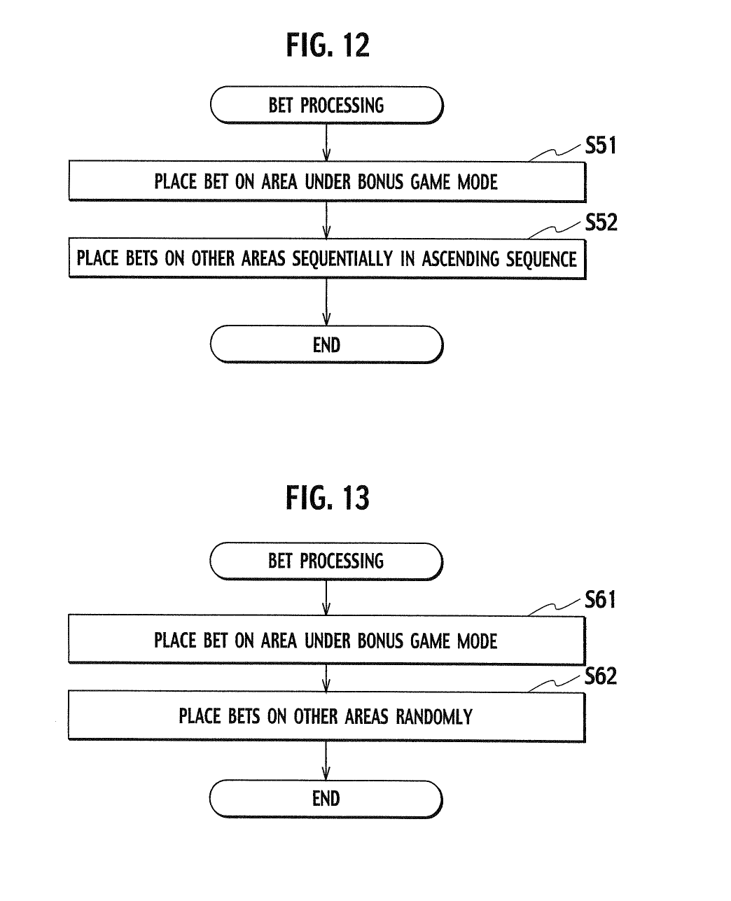

Next, the CPU 106 executes bet processing for placing a bet on each of the slot games on the activated slot game areas A1 to A11 (step S15). The bet processing will be described later in detail with reference to FIG. 12 and FIG. 13.

After step S15, the CPU 106 determines a payline(s) to be activated according to the bet amount for each of the slot game areas A2 to A11 except the central slot game area A1 (step S16). In this processing, as described above, the line L1 is activated when one credit is bet on each of the slot games on the slot game areas A2 to A11, the lines L1, L2, and L3 are activated when two credits are bet, and all of the lines L1 to L5 are activated when three credits are bet (see FIG. 17).

Although a detailed description will be given later, it is also possible to place a bet randomly on each slot game on the slot game areas A1 to A11. In this case, it is not limited that a bet is placed on each of the slot game areas A1 to A11 in numerical order of the areas. For example, when the slot game areas A1, A3, A6, A8, and A9 are activated, one credit is bet, respectively, in the order of A8, A3, A9, A1, and A6.

Then, the CPU 106 determines whether or not the start switch 27 has been pressed (step S17). The slot game is executed on each of the slot game areas A2 to A11 except the central slot game area A1 when the start switch 27 has been pressed (step S18).

Next, the CPU 106 determines whether or not an outcome of the slot games on the slot game areas A2 to A11 has met a prescribed condition, respectively (step S19). Here, it is determined that the prescribed condition has been met when a winning combination is achieved on an activated paylines in at least one slot game (including the bonus game) on activated slot game areas A2 to A11. The present processing ends when the prescribed condition has not been met (step S19: NO). On the other hand, the CPU 106 executes the slot game on the central slot game area A1 (step S19-1) when the prescribed condition has been met (step S19: YES). Then, the present processing ends.

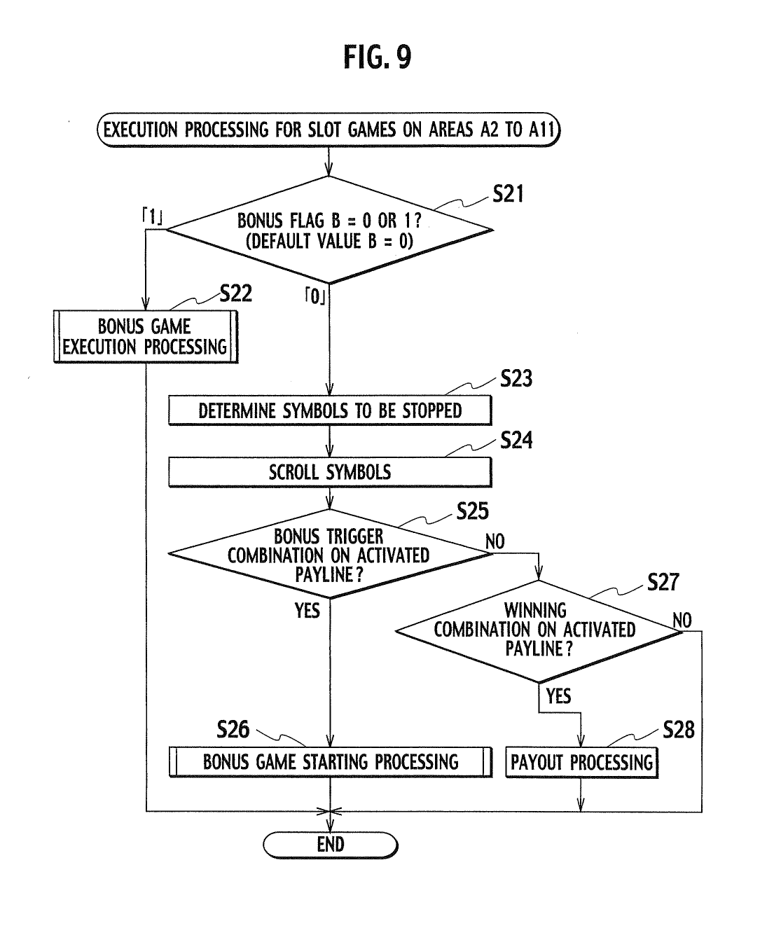

Next, a processing procedure of the slot game executed on each of the activated slot game areas A2 to A11 is described with reference to FIG. 9. In the following description, a slot game in an activated slot game area A6 is described as an example. In the present embodiment, a slot game(s) is executed also on a non-activated slot game area(s). However, in respect to the non-activated slot game area(s), no payout is awarded even if a winning combination is achieved and a trigger combination does not cause a trigger.

First, the CPU 106 determines whether a bonus flag of the slot game area A6 is “0” or “1” (step S21). The default value of the bonus flag is “0” and set to “1” when the bonus game is to be executed.

The CPU 106 determines symbols to be stopped (hereinafter, simply referred to as stop symbols) in each of the display areas q11 to q33 on the slot game area A6 when the bonus flag is “0” (step S23). By this processing, symbols (“17”, “BELL”, “APPLE”, etc.) to be displayed in each of the display areas q11 to q33 are determined.

Next, the CPU 106 scrolls symbols in the display areas q11 to q33 (step S24). Then, the symbols stop in each of the display areas q11 to q33 after a predetermined time has elapsed. The displayed symbols at this time are the stop symbols determined in step S23.

Then, the CPU 106 determines whether or not a bonus trigger combination (three 7's: FIG. 18) is rearranged on any of the activated paylines (step S25). For example, it is determined whether or not the bonus trigger combination is achieved on any of the paylines L1 to L5 (FIG. 17) when all of the lines L1 to L5 are activated.

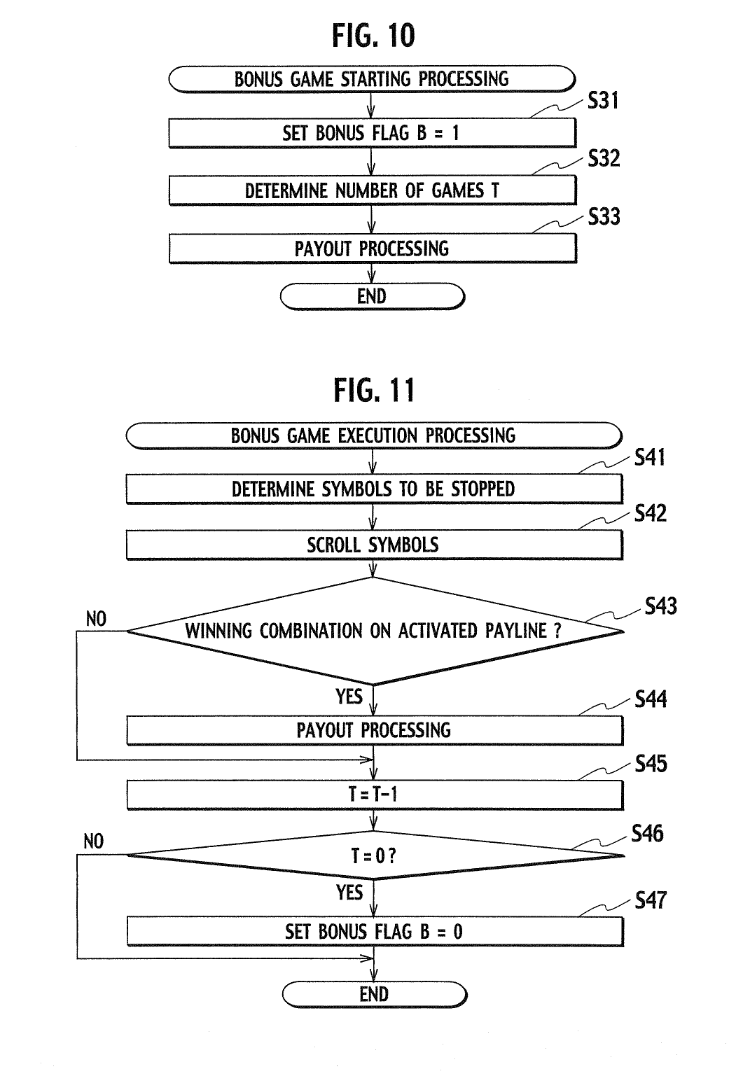

Then, the CPU 106 executes bonus game starting processing (step S26) when the bonus trigger combination is achieved on any of the paylines L1 to L5. The bonus game starting processing will be described later with FIG. 10.

On the other hand, the CPU 106 determines whether or not one of winning combinations has been achieved on any of the activated paylines (step S27) when the bonus trigger combination has not been achieved. A payout is awarded according to a winning combination (step S28) when the winning combination has been achieved. On the other hand, the CPU 106 does not award a payout when a winning combination has not been achieved. And then the CPU 16 ends the slot game. It may be possible to cash-out a medal(s) equivalent to a payout amount through the cash-out chute 28 or to add a credit(s) equivalent to a payout amount to the internally stored credits, when a payout is to be awarded.

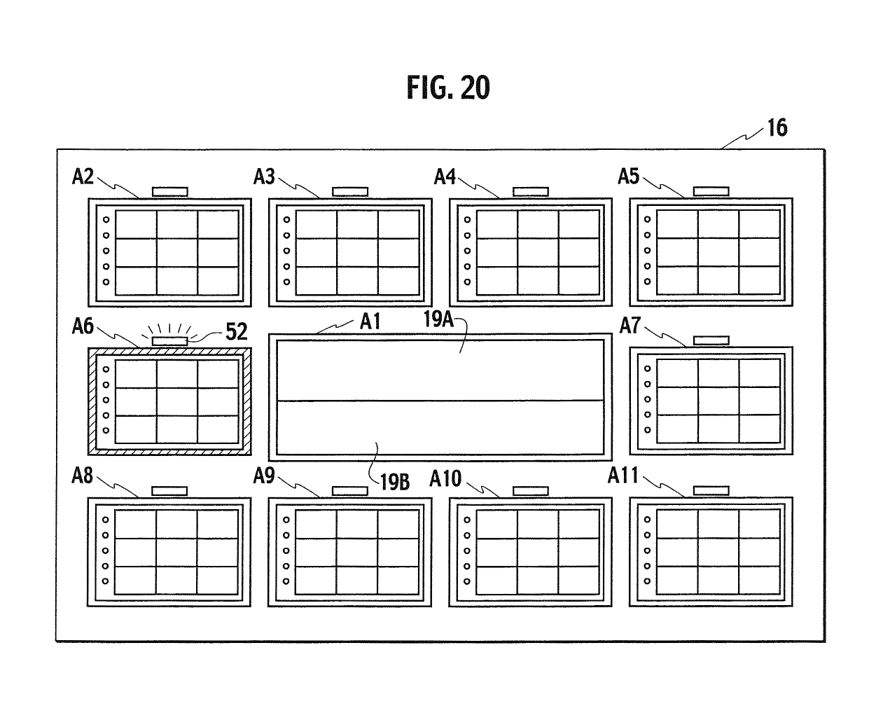

Next, the bonus game starting processing is described with reference to the flowchart in FIG. 10. The bonus flag is set to “1” (step S31) when the bonus trigger is achieved in step S25 in FIG. 9. At this time, the bonus game indicator 52 of the slot game area A6 lights up as shown in FIG. 20 to notify the player that the bonus game is being executed on the slot game area A6.

Then, the CPU 106 determines the number of the bonus games T (step S32). The number of games T is, for example, fifty. The number of games T may be fixed or determined each time randomly by the CPU 106. The number of games T is stored in the RAM 110.

Next, a payout for the bonus trigger is awarded (step S33) For example, a 15-credit (15-medal) payout is awarded in the present embodiment. Then, the present processing is ended.

Bonus game execution processing is executed (step S22) for the next slot game on the slot game area A6 after step 21 in FIG. 9, when the bonus flag has been set to “1” in the bonus game start processing (step S31 in FIG. 10).

The bonus game execution processing is described below with reference to the flowchart in FIG. 11. The CPU 106 executes processing for determining stop symbols (step S41) when the bonus game execution is started. This processing is the same processing as that in step S23 in FIG. 9. In step S41, three 7's are not rearranged on the payline, but the stop symbols are determined so that a winning combination is achieved with a high probability. In other words, a winning combination (three BELLs, three APPLEs or at least one CHERRY on the leftmost in FIG. 18) is achieved on an activated payline with higher probability in the bonus game than in the normal slot game.

Next, the CPU 106 scrolls the symbols in the display areas q11 to q33 (step S42). This processing is the same as that in step S24 in FIG. 9. Then, the symbols stop in each of the display areas q11 to q33 after a predetermined time has elapsed. At this time, the displayed symbols are the stop symbols determined in step S41.

Next, the CPU 106 determines whether or not a winning combination has been achieved on the activated payline (step S43). A payout is awarded according to a winning combination (step S44) when the winning combination has been achieved. On the other hand, the CPU 106 does not award a payout when a winning combination has not been achieved.

Then, the CPU 106 decrements the number of games T stored in the RAM 110 (step S45).

Next, the CPU 106 determines whether or not the number of games T is “0” (step S46). The bonus flag is reset to “0” when “T=0” (step S47). In other words, the bonus flag is reset and the bonus game is ended when the predetermined number of bonus games has been expended.

Next, the bet processing (step S15 in FIG. 8) is described with reference to a flowchart in FIG. 12 and a table in FIG. 21.

The CPU 106 first places a bet preferentially on the bonus slot game(s) on the activated slot game areas A2 to A11 (step S51) after the bet switch 25 has been pressed or a medal(s) has been inserted into the medal insertion slot 21. After that, a bet is placed sequentially on the slot game on the activated slot game areas A1 to A11 in ascending order of the area numbers (step S52).

For example, when all of the slot game areas A1 to A11 are activated and the bonus game is being played on the slot game area A8, the first to third credits are bet on the bonus slot game on the slot game area AB as shown in FIG. 21. Then the fourth credit is bet on the slot game on the slot game area A1 and the fifth credit is bet on the slot game on the slot game area A2. One bet is placed one by one on the remaining slot game areas A2-A7 and A9-A11 (except the slot game area AS and the central slot game area A1) according to the above procedure. Then, the above procedure is repeated to place second and third bets. In this manner, thirty-one credits can be expended to place a 1-credit bet on the central slot game area A1 and a 3-credit bet on each of the other slot game areas A2 to A11, respectively.

An example has been described above, in which the number of activated slot game areas during the bonus game is one (slot game area AB). However, a 3-credit bet is placed preferentially on the bonus slot game on each of the activated slot game areas when the bonus games are executed simultaneously on two or more activated slot game areas. And then, one bet is placed sequentially on the slot game on each of the activated slot game areas.

FIG. 13 is a flowchart of another example of the bet processing. In this processing, the CPU 106 first places a bet preferentially on the bonus slot game(s) on the activated slot game areas A2 to A11 (step S61) after the bet switch 25 has been pressed or a medal(s) has been inserted, as in the case shown in FIG. 12. After that, a bet is placed sequentially on the slot game on the activated slot game areas A1 to A11 in random order (step S62). At this time, the bet order for the slot games on the slot game areas A1 to A11, which are not during the bonus game, is determined randomly by the CPU 106 at each game play.

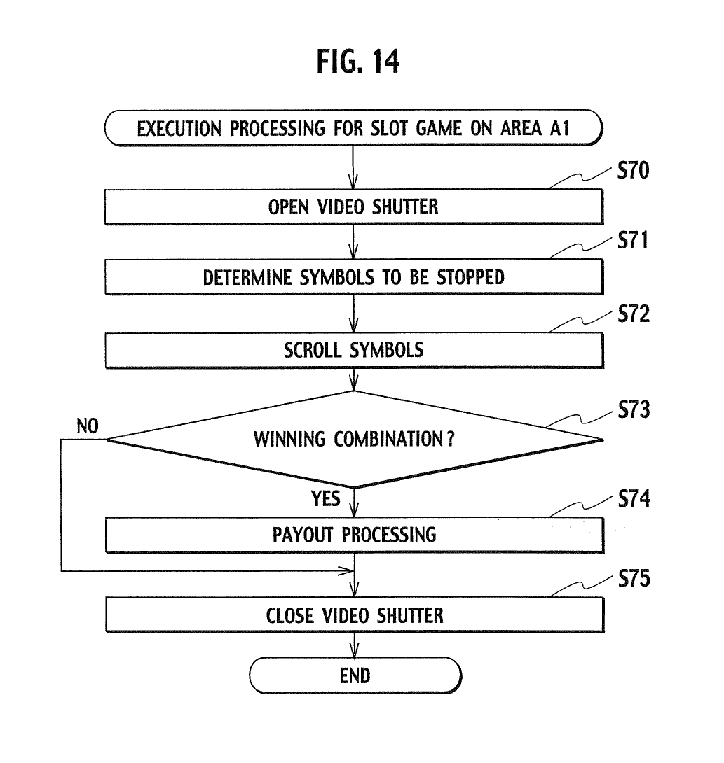

Next, a slot bonus game processing procedure executed on the activated central slot game area A1 is described with reference to FIG. 14.

First, the CPU 106 changes the video shutter 19 displayed on the slot game area A1 from a closed state to an opened state (step S70). By this processing, the three display areas q1 to q3 are appeared on the slot game area A1 in place of the closed video shutter 19. Then, the reels 3A to 3C had been hidden by the video shutter 19 are exposed so that they can be visually recognized by the player through the display areas q1 to q3.

Next, the CPU 106 determines stop symbols in each of the display areas q1 to q3 on the slot game area A1 (step S71). By this processing, symbols (“7”, “BELL”, “APPLE”, etc.) to be displayed in each of the display areas q1 to q3 are determined.

And then, the CPU 106 scrolls the symbols in each of the display areas q1 to q3 (step S72). Then, the symbols stop in each of the display areas q1 to q3 after a predetermined time has elapsed. Here, the displayed symbols are the stop symbols determined in step S71.

Then, the CPU 106 determines whether or not a winning combination (FIG. 17) has been rearranged (step S73) A payout is awarded according to a winning combination (step S74) when the winning combination has been rearranged. On the other hand, the CPU 106 does not award a payout when a winning combination has not been rearranged. And then, the CPU 106 ends the slot game on the center slot game A1 regardless of whether or not a payout has been awarded. It may be possible to cash-out a medal(s) equivalent to a payout amount through the cash-out chute 28 or to add a credit(s) equivalent to a payout amount to the internally stored credits, when a payout is to be awarded.

The CPU 106 closes the shutter doors 19A, 19B to hide the display areas q1 to q3 after the slot game on the slot game area A1 has ended. As a result, the closed video shutter 19 is displayed on the slot game area A1 (step S75). The display areas q1 to q3 are not displayed any longer after the closed video shutter 19 has been displayed on the slot game area A1. The reels 3A to 3C that have been visually recognized through the display areas q1 to q3 are hidden by the video shutter 19 and the player cannot visually recognize the reels 3A to 3C.

In this manner, the slot game areas A1 to A11 to be activated can be selected arbitrarily by the touch operation onto the slot game areas A1 to A11 on the lower display 16 in the slot machine 10 of the present embodiment. And then, the slot game is executed after a bet(s) has been placed on the activated slot game areas A2 to A11.

Further, the video shutter 19 is opened on the central slot game area A1 when a winning combination is achieved in the slot game on at least one of the slot game areas A2 to A11, on which a bet has been placed. And then, the reels 3A to 3C having been hidden by the video shutter 19 can become visually recognized through the display areas q1 to q3. In this state, the slot game by the reels 3A to 3C is executed on the central slot game area A1.

The video shutter 19 is closed after the slot game has ended on the central slot game area A1. As a result, the reels 3A to 3C that have been visually recognized through the display areas q1 to q3 are hidden by the video shutter 19 and the player cannot visually recognize the reels 3A to 3C.

Therefore, in the slot machine 10 of the present embodiment, the slot games on the slot game areas A2 to A11 on the LCD panel 17 and the slot game by the reels 3A to 3C on the slot game area A1 can be executed continuously in a single game play if a winning combination is achieved on at least one of the activated slot game areas A2 to A11, on which a bet has been placed.

Further, in the slot machine 10 according to the present embodiment, the slot game by the reels 3A to 3C on the slot game area A1 is executed with opening/closing the video shutter 19. Video shutters are not provided on the slot game areas A2 to A11 by the LCD panel 17. Therefore, it is possible to provide a player with a special expectation for the slot game on the slot game area A1 by the special effect of opening/closing the video shutter 19.

In addition, since a player can arbitrarily select the slot game areas A1 to A11 to be activated by the touch operation, the player can freely select the slot game areas A1 to A11 to play the slot game(s) on which a bet is to be placed.

In the present embodiment, an example has been described above, in which the slot game area(s) A1 to A11 on which a bet(s) is to be placed is preliminarily selected. Then, a total bet amount is input and distributed on the selected (activated) slot game area(s) A1 to A11. However, it may also be possible that a total bet amount is preliminarily input and then the slot game area(s) A1 to A11 on which a bet(s) is to be placed is selected. Then, the bet amount is distributed on the selected slot game area(s) A1 to A11.

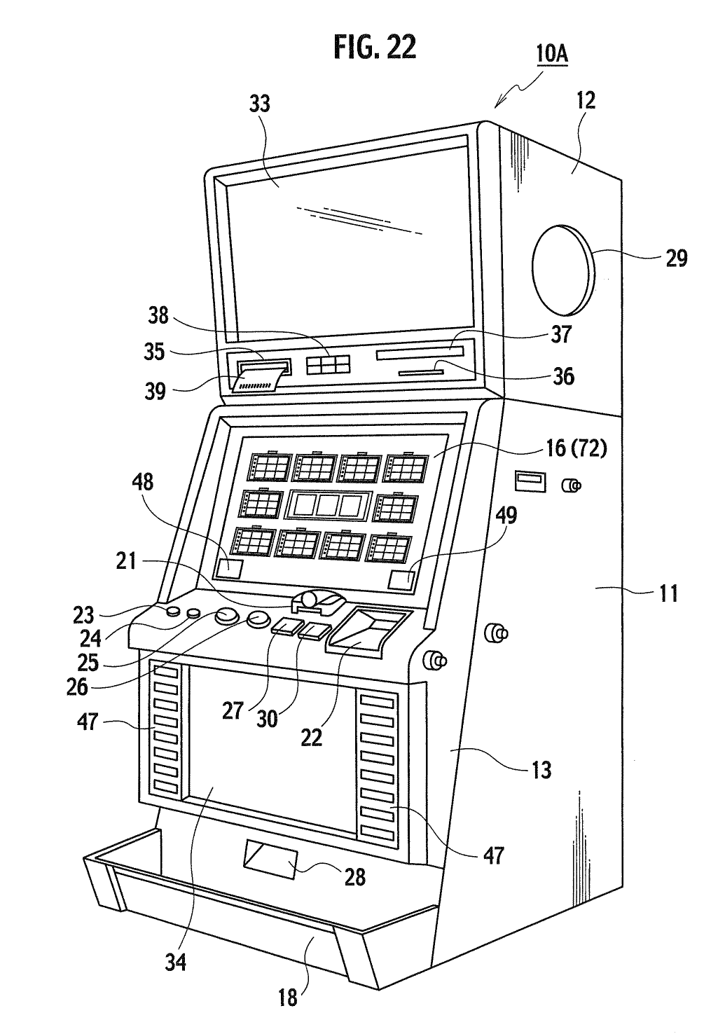

A slot machine of a second embodiment, which follows this procedure, will be described below with reference to FIG. 22 to FIG. 24.

As shown in FIG. 22, a slot machine 10A of the present embodiment differs from the slot machine 10 (FIG. 3) of the first embodiment described above in that a fix switch 30 and a selectable area counter 49 at the bottom right of the lower display 16 (the LCD panel 17) are added.

The fix switch 30 is one of the various operational switches disposed nearby the vicinity of the medal insertion slot 21 and the bill validator 22. The fix switch 30 is a switch for fixing a slot game area(s) to be activated among the slot game areas A1 to A11. A player is no longer able to select a slot game area(s) for activation the touch operation after pressing the fix switch 30.

The selectable area counter 49 displays the maximum number of slot game areas A1 to A11 that are selectable to be activated. If a bet amount, which has been input by pressing of the bet switch 25 or inserting a medal(s) into the medal insertion slot 21, is ten or less, the input bet amount is displayed as is in the selectable area counter 49. If the input bet amount is equal to or greater than eleven, a value “11” is displayed in the selectable area counter 49.

In the slot machine 10A of the present embodiment, the activation indicating frame(s) 51 of the selected slot game area(s) A1 to A11 is blinked between having been selected (activated) by touch operation and being fixed by the fix switch 30. Since the activation indicating frame(s) 51 is blinked, the player can easily recognize the slot game area(s) A1 to A11 on which a bet(s) is about to be placed.

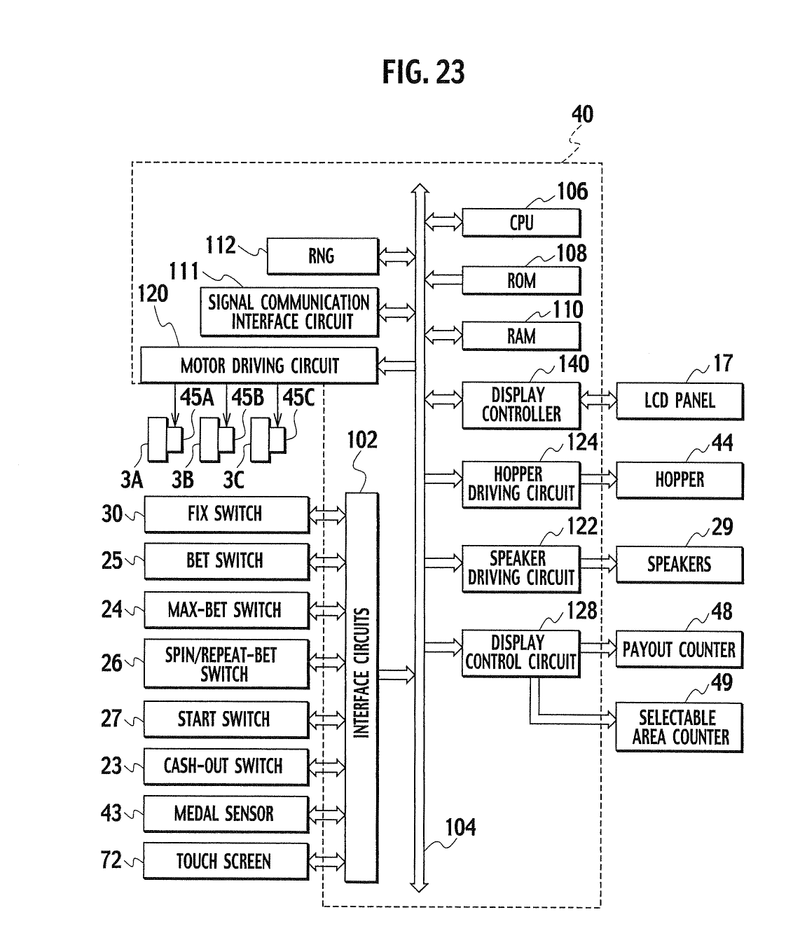

As shown in a block diagram of FIG. 23, the slot machine 10A of the present embodiment differs from the slot machine 10 (FIG. 7) of the first embodiment described above in that the fix switch 30 is connected to the interface circuits 102 and the selectable area counter 49 is connected to the display control circuit 128.

In addition to the differences in outside appearance and electrical configuration described above, the slot machine 10A of the present embodiment differs from the slot machine 10 of the first embodiment in part of the processing executed by the CPU 106. The slot game execution processing of the present embodiment will be described below (in particular, the part different from that of the first embodiment).

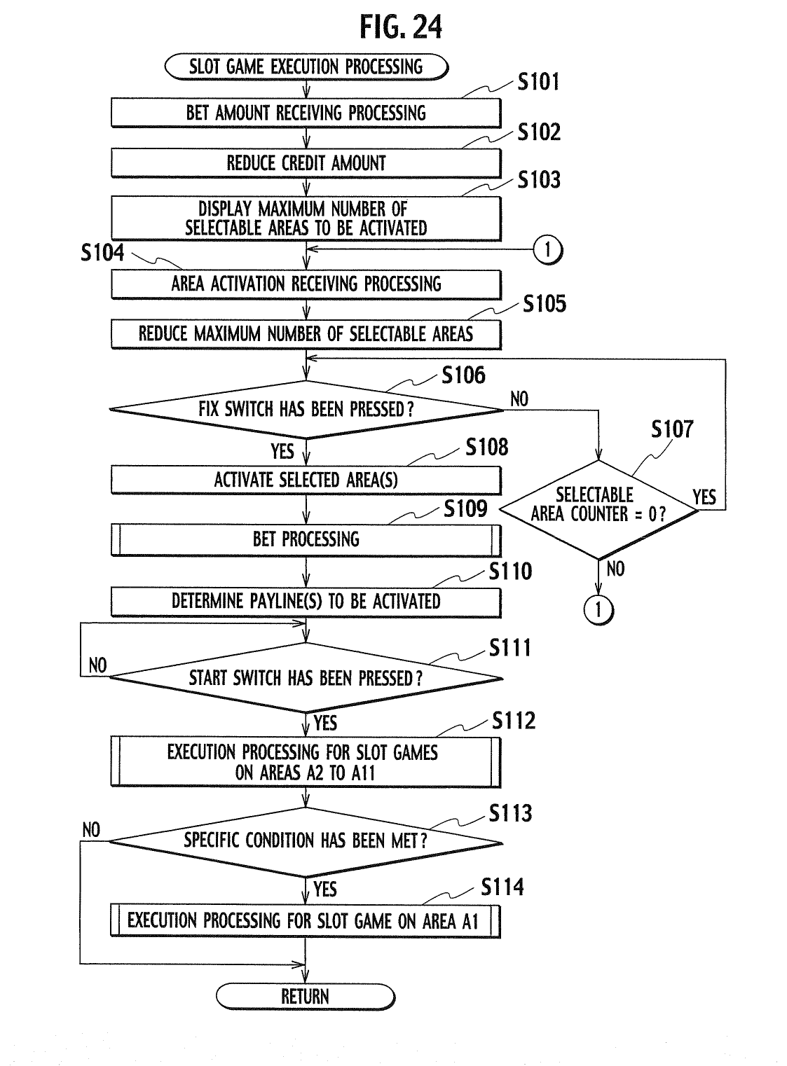

FIG. 24 is a flowchart showing slot game execution processing that the CPU 106 of the slot machine 10A of the present embodiment executes according to the game execution programs stored in the ROM 108.

First, the CPU 106 executes bet amount receiving processing for receiving a total bet amount on the slot games on the slot game areas A1 to A11 to be activated (step S101). In the bet amount receiving processing, pressing of the bet switch 25 by the player is detected and the total bet amount is calculated. Then, the CPU 106 subtracts the bet amount having been input from an internally stored credit amount (step S102). For example, if the stored credit amount is 50 credits and a 20-credit bet amount is received, the stored credit amount will be 30 credits.

It is also possible to input a total bet amount by inserting a medal(s) into the medal insertion slot 21. In this case, the CPU 106 recognizes the number of as a bet amount. In this case, it is not needed to execute subtraction from the stored credit amount in step S102.

Next, the CPU 106 calculates the maximum number of slot game areas A1 to A11 that can be selectable to activate based on the total bet amount and displays it on the selectable area counter 49 (step S103). Then, the CPU 106 executes area activation receiving processing for receiving a selection for activating the slot game areas A1 to A11 (step S104). In the activation receiving processing, the slot game areas A1 to A11, which have been touched by the player, are detected by the touch screen 72. The CPU 106 blinks the activation indicating frame 51 on the peripheral edge of the selected slot game area(s) to notify the player of the selected slot game area(s).

Next, the CPU 106 calculates the maximum number of selectable slot game areas and displays the calculated number on the selectable area counter 49 (step S105). The value on the selectable area counter 49 is reduced by one when one of non-selected slot game areas A1 to A11 has been newly selected. For example, the calculated maximum number is eleven when the bonus game is not being executed and none of the slot game areas A1 to A11 is selected yet. Here, the value on the selectable area counter 49 is reduced to ten when the slot game area A1 is selected. In the downstream bet processing (the content of the processing is the same as that of the first embodiment), there may be the case where the bet amount is distributed preferentially (during the execution of the bonus game). For example, three credits can be expended at once when the slot game area, on which the bonus game is being executed, is selected. The calculated maximum number is eleven when the bonus game is being executed on one slot game area and none of the slot game areas A1 to A11 is selected yet. Here, the remaining number of bet amounts becomes eight when the slot game area, on which the bonus game is being executed, is selected at first. That is, the calculated maximum number is eight. In this manner, the CPU 106 calculates the maximum number of selectable slot game areas based on the total bet amount and distribution processing in the downstream bet processing.

Subsequently, the CPU 106 determines whether or not the fix switch 30 has been pressed (step S106). The CPU 106 determines whether or not the value on the selectable area counter 49 is “0” (step S107) when the fix switch 30 has not been pressed (step S106: NO). The processing returns to step S104 when the value on the selectable area counter 49 is not “0” (step S107: NO). On the other hand, the processing returns to step S106 when the value on the selectable area counter 49 is “0” (step S107: YES). The CPU 106 activates the selected slot game areas A1 to A11 (step S108) when it is determined that the fix switch 30 has been pressed (step S106: YES). The CPU 106 lights up the activation indicating frame 51 on the peripheral edge of the activated slot game area(s) to notify the player of the activated slot game area(s).

Next, the CPU 106 executes the bet processing for placing a bet on each of the slot games on the activated slot game areas A1 to A11 (step S109).

The CPU 106 determines a payline(s) to be activated according to a bet amount on each of the slot game areas A2 to A11 (step S110) after the betting processing has finished. Subsequently, the CPU 106 determines whether or not the start switch 27 has been pressed (step S111). The slot game is executed on each of the slot game areas A2 to A11 (step S112) when the start switch 27 has been pressed (step S111: YES).

Next, the CPU 106 determines whether or not the slot games on the slot game areas A2 to A11 have met a prescribed condition (step S113). Here, it is determined that the prescribed condition has been met if a winning combination has been achieved on the payline in any of the slot games (including the bonus game) on the activated slot game areas A2 to A11. The present processing ends when the prescribed condition has not been met (step S113: NO). On the other hand, the CPU 106 executes the slot game on the central slot game area A1 (step S114) when the prescribed condition has been met (step S113: YES). After that, the present processing ends.

Each processing in step S109 to step S114 is the same as that in step S15 to step S19-1 (FIG. 8) of the first embodiment.

As described above, in the slot machine 1A of the present embodiment, the total bet amount is held after the bet switch 25 has been pressed or a medal(s) has been inserted into the medal insertion slot 21. Then, the maximum number of slot game areas A1 to A11 that can be selectable to activate is calculated according to the held total bet amount and then displayed on the selectable area counter 49.

Then, the slot game areas A1 to A11 are arbitrarily selected by the touch operation onto the slot game areas A1 to A11 on the lower display 16 within the range of the calculated maximum number. The total bet amount is distributed on the slot games on the selected slot game areas A1 to A11 (the slot game areas A1 to A11 on which a bet has been placed are activated). Then, the slot game is executed on each of the activated slot game areas A2 to A11.

The slot game is executed by the reels 3A to 3C on the central slot game area A1 when a winning combination has been achieved on at least one of the activated slot game areas A2 to A11 on which a bet was placed.

As a result, also in the slot machine 10A of the present embodiment, the slot game on each of the game areas A2 to A11 on the LCD panel 17 and the slot game by the reels 3A to 3C on the slot game area A1 can be executed continuously in a single game play.

Further, in the slot machine 10A according to the present embodiment, the slot game by the reels 3A to 3C on the slot game area A1 is executed with opening/closing the video shutter 19. Video shutters are not provided on the slot game areas A2 to A11 by the LCD panel 17. Therefore, it is possible to provide a player with a special expectation for the slot game on the slot game area A1 by the special effect of opening/closing the video shutter 19.

In addition, since a player can arbitrarily select the slot game areas A1 to A11 to be activated by the touch operation, the player can freely select the slot game areas A1 to A11 to play the slot game(s) on which a bet is to be placed.

Further, in the present embodiment, the slot game areas A1 to A11 to be activated are selected after the total bet amount is determined. Therefore, since the maximum number of slot game areas A1 to A11 which can be activated is calculated preliminarily, it is possible to prevent a selection of the slot game areas A1 to A11 beyond the calculated maximum number.

Since a bet(s) is placed preferentially on the bonus game(s) on the slot game area(s) A2 to A11, the slot game area(s) A2 to A11 which is to be expected a larger payout by the bonus game can be activated without fail.

In the first and second embodiments described above, the slot game area A1 (corresponding to the slot game area provided with the mechanical reels in claims) is arranged in the center of the lower display 16, surrounded by the other slot game areas A2 to A11. However, the slot game area A1 (the slot game area provided with the mechanical reels) may be disposed not on the lower display 16 but at another different position, independently from the other slot game areas A2 to A11.

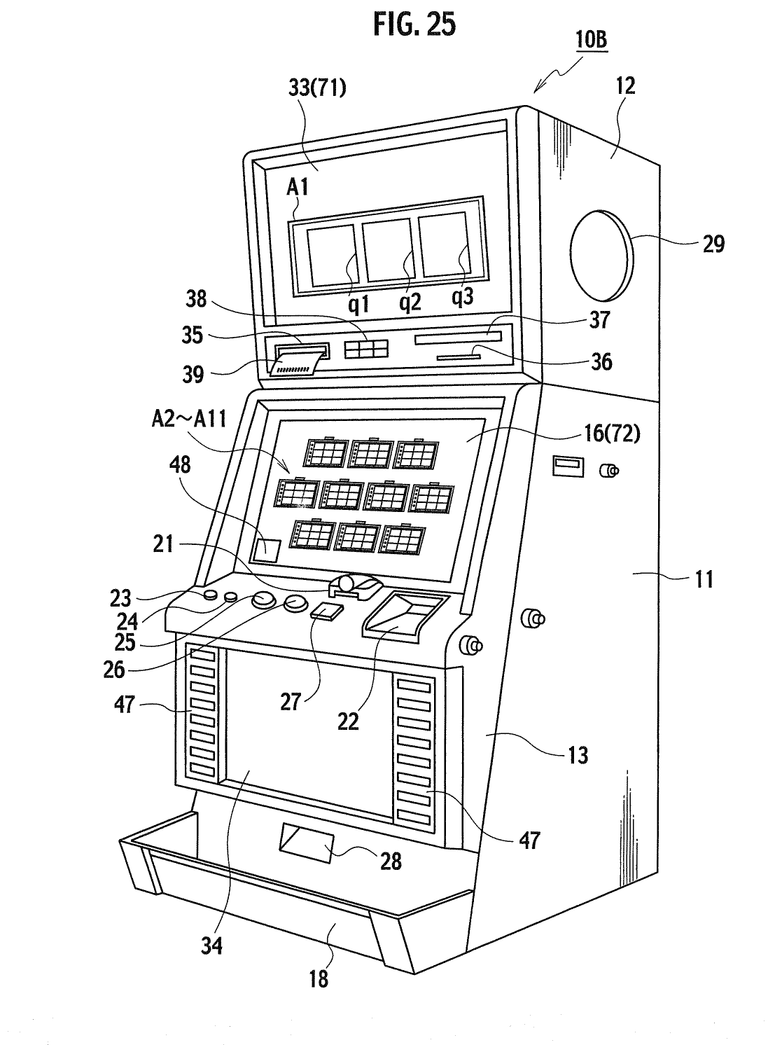

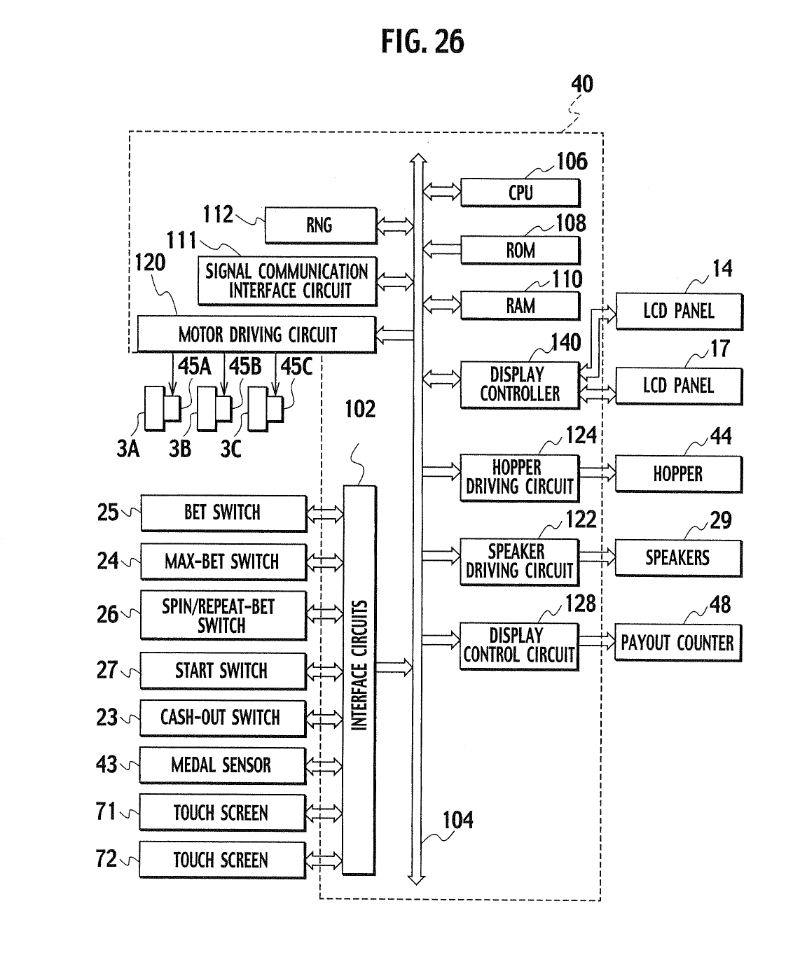

A slot machine of a third embodiment, which has this configuration, will be described below with reference to FIG. 25 and FIG. 26.

As shown in FIG. 25, in a slot machine 10B of the present embodiment, the slot game area A1 (the slot game area provided with the mechanical reels) is disposed on the upper display 33 and the other slot game areas A2 to A11 are disposed on the lower display 16. Therefore, the LCD panel 14 (see FIG. 26) is disposed behind the upper display 33 in the slot machine 10B. In addition, a touch screen 71 is provided on the surface of the LCD panel 14 in order to detect the player's touch operation onto the slot game area A1.

As shown in the block diagram in FIG. 26, in the slot machine 10B, the LCD panel 14 of the upper display 33 is connected to the display controller 140 along with the LCD panel 17 of the lower display 16, in addition to the electrical configuration (FIG. 7) of the slot machine 10 in the first embodiment. Further, in the slot machine 10B, the touch screen 71 is connected to the interface circuits 102.

In the slot machine 10B thus configured, the same processing as of the slot machine 10 in the first embodiment is executed by the CPU 106 of the controller 40, basically. However, the present embodiment differs from the first embodiment in that the display control of the slot game area A1 (the video shutter 19) is executed via the LCD panel 14 of the upper display 33. Further, it differs from the first embodiment in that the player's touch operation onto the slot game area A1 is detected by the touch screen 71 of the LCD panel 14.

A variation of the slot machine 10B may be possible. For example, the slot game area A1 by the reels 3A to 3C is disposed on the lower display 16 and the other slot game areas A2 to A11 by the LCD panel 17 are disposed on the upper display 33.

In this case, the same processing as of the slot machine 10 in the first embodiment is executed by the CPU 106 of the controller 40 basically. However, the present embodiment differs from the first embodiment in that the display control of the slot game areas A2 to A11 is executed via the LCD panel 14 of the upper display panel 33. In addition, the display control of the slot game area A1 (the video shutter 19) is executed via the LCD panel 17 of the lower display 16. Further, it also differs from the first embodiment in that the player's touch operation onto the slot game area A1 is detected by the touch screen 72 of the LCD panel 17. Furthermore, the player Is touch operation onto the slot game areas A2 to A11 is detected by the touch screen 71 of the LCD panel 14.

As shown in the slot machine 10B and its variation described above, it is possible to simplify the display control of the LCD panel 17 (or the LCD panel 14) by disposing the slot game area A1 by the reels 3A to 3C and the slot game areas A2 to A11 by the LCD panel 17 (or the LCD panel 14) dispersedly on the upper display 33 and the lower display 16.

In the slot machines 10, 10A, and 10B in the first to third embodiments described above, the slot game area A1 (corresponding to the slot game area provided with the mechanical reels in claims) is opened/closed by the video shutter 19. However, it may also be possible to open/close the slot game area A1 by a mechanical shutter.

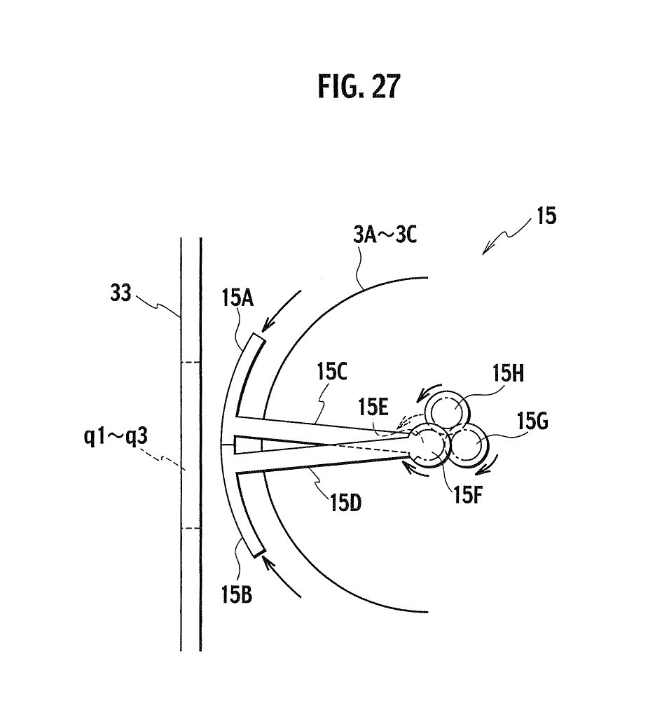

A slot machine of a fourth embodiment, which has this configuration, will be described below with reference to FIG. 27 to FIG. 30.

The slot machine in the present embodiment has the same outside appearance as of the slot machine 10B in the third embodiment shown in FIG. 25. In the slot machine in the present embodiment, the slot game area A1 of the upper display 33 is opened/closed by a mechanical shutter unit in place of the video shutter 19 of the slot machine 10B.

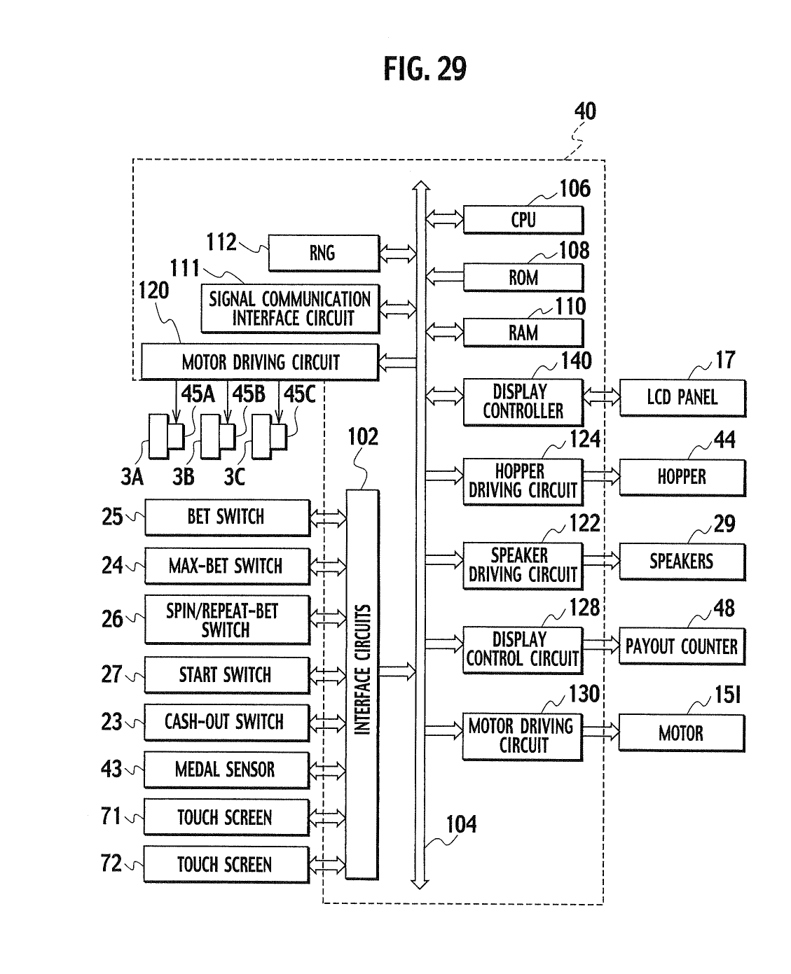

As shown in FIG. 27, a shutter unit 15 (corresponding to a “shutter” in claims) of the slot machine in the present embodiment has upper and lower shutter doors 15A, 15B, arms 15C, 15D extended from each of the shutter doors 15A, 15B, and gears 15E, 15F formed at the end of each of the arms 15C, 15D. In addition, the shutter unit 15 has a drive gear 15G engaged with the upper gear 15E, an intermediate gear 15H transmitting the drive force to the lower gear 15F by reversely rotating the drive gear 15G, and a motor 15I (see FIG. 29) that drives the drive gear 15G. Both the gears 15E, 15F are offset in the rotation axis direction. Therefore, the intermediate gear 15H is not engaged with the upper gear 15E. In addition, the drive gear 15G is not engaged with the lower gear 15F.

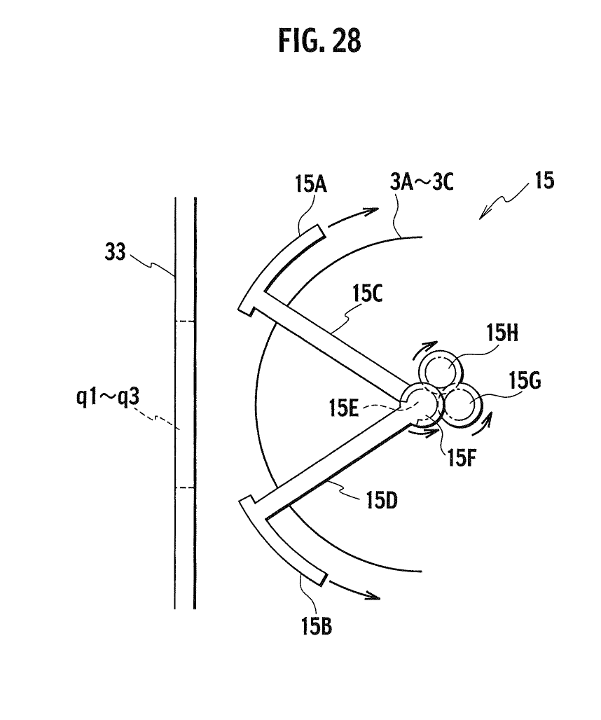

When the motor 15I rotates, the rotation of the drive gear 15G is transmitted to the upper gear 15E directly. The upper gear 15E rotates to the counter rotating direction against the rotation direction of the drive gear 15G. Simultaneously, the rotation of the drive gear 15G is transmitted to the lower gear 15F via the intermediate gear 15H. The lower gear 15F rotates to the same rotating direction as the rotation direction of the drive gear 15G. Therefore, the arms 15C, 15D of the upper and lower shutter door 15A, 15B swing about a common swing axis toward opposite directions each other. As a result, as shown in FIG. 27 and FIG. 28, the upper and lower shutter doors 15A, 15B move toward the opposite directions each other along the peripheral surfaces of the reels 3A to 3C to open/close the slot game area A1. As described above, the reels 3A to 3C are hidden (closed: FIG. 27) or exposed (opened: FIG. 28) at the slot game area A1.

In the slot machine in the present embodiment, same as the slot machine 10B in the third embodiment, the touch screen 71 is provided on the surface of the LCD panel 14 in order to detect the player's touch operation onto the slot game area A1.

As shown in the block diagram in FIG. 29, in the slot machine in the present embodiment, a motor drive circuit 130 for the shutter unit 15 is provided additionally and the motor 15I is connected to the motor drive circuit 130, in addition to the electrical configuration (FIG. 7) of the slot machine 10 in the first embodiment. Further, the touch screen 71 is connected to the interface circuits 102.

In the slot machine in the present embodiment thus configured, the same processing as of the slot machine 10 in the first embodiment is executed by the CPU 106 of the controller 40, basically. However, the present embodiment differs from the first embodiment in that the player's touch operation onto the slot game area A1 is detected by the touch screen 71 of the LCD panel 14. Further, it differs from the first embodiment in the slot game execution processing on the slot game area A1.

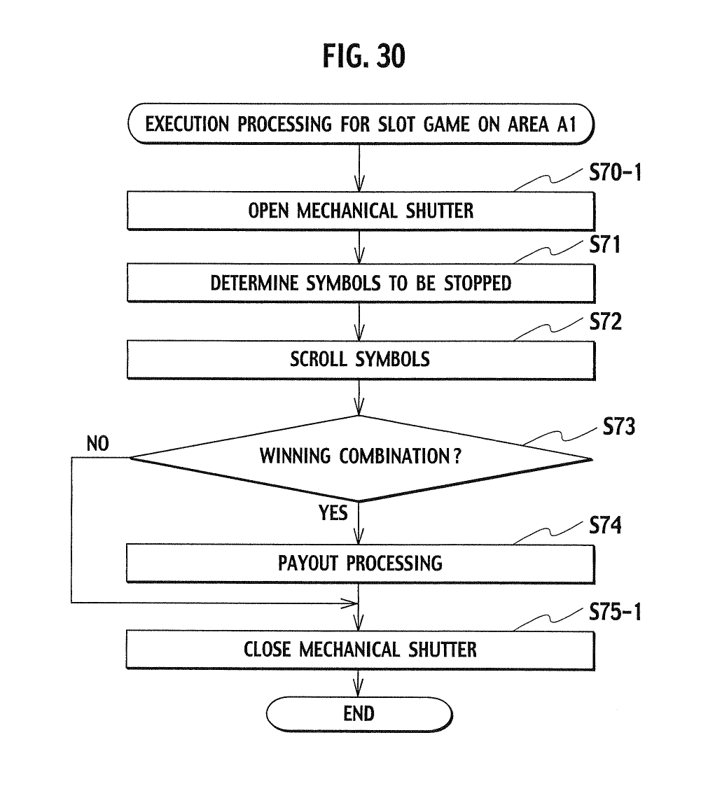

In the present embodiment, the CPU 106 executes the slot game execution processing on the slot game area A1 shown in FIG. 30. First, the CPU 106 opens the upper and lower shutter doors 15A, 15B of the shutter unit 15, which had been closed, on the slot game area A1 (step S70-1). By this processing, the three display areas q1 to q3 are appeared on the slot game area A1. Then, the reels 3A to 3C had been hidden by the shutter unit 15 are exposed so that they can be visually recognized by the player through the display areas q1 to q3.

Next, the CPU 106 determines stop symbols in each of the display areas q1 to q3 on the slot game area A1 (step S71). By this processing, symbols (“7”, “BELL”, “APPLE”, etc.) to be displayed in each of the display areas q1 to q3 are determined.

And then, the CPU 106 scrolls the symbols in each of the display areas q1 to q3 by spinning the reels 3A to 3C (step S72). Then, the symbols stop in each of the display areas q1 to q3 after a predetermined time has elapsed. Here, the displayed symbols are the stop symbols determined in step S71.

Then, the CPU 106 determines whether or not a winning combination (FIG. 17) has been rearranged (step S73). A payout is awarded according to a winning combination (step S74) when the winning combination has been rearranged. On the other hand, the CPU 106 does not award a payout when a winning combination has not been rearranged. And then, the CPU 106 ends the slot game on the center slot game A1 regardless of whether or not a payout has been awarded. It may be possible to cash-out a medal(s) equivalent to a payout amount through the cash-out chute 28 or to add a credit(s) equivalent to a payout amount to the internally stored credits, when a payout is to be awarded.

The CPU 106 closes the upper and lower shutter doors 15A, 15B to hide the display areas q1 to q3 after the slot game on the slot game area A1 has ended. As a result, the shutter unit 15 is closed on the slot game area A1 (step S75-1). The reels 3A to 3C that have been visually recognized through the display areas q1 to q3 are hidden by the shutter unit 15 and the player cannot visually recognize the reels 3A to 3C.

In the slot machine in the present embodiment thus configured, the same operations as of the slot machine 10B in the third embodiment are executed except in that the slot game area A1 is opened/closed by the shutter unit 15.

In this manner, it is possible to provide the same advantages as of the slot machine 10B in the third embodiment also in the slot machine in the present embodiment.

A variation of the slot machine of the present embodiment may be possible. For example, the slot game area A1 by the shutter unit 15 and the reels 3A to 3C is disposed on the lower display 16 and the other slot game areas A2 to A11 by the LCD panel 17 are disposed on the upper display 33.

In the present embodiment, the video shutter 19 of the slot machine 10B in the third embodiment is replaced with the mechanical shutter unit 15. Similarly, it is also possible to use the mechanical shutter unit 15 in place of the video shutter 19 of the slot machines 10, 10A in the first and second embodiments.

The slot machines and the playing methods thereof are described as above based on the embodiments schematically shown, however, the present invention is not limited to the above. The configuration of each part can be replaced with an arbitrary configuration having the same function.

For example, in the above embodiments, the examples are shown, in which the slot games are executed in all of the slot game areas A1 to A11 regardless of activation. However, it may also be possible to execute the slot games only in the activated slot game areas A1 to A11. Alternatively, a movie, which is looked like a slot game, may be played on each non-activated slot game area.

In the above embodiments, a bet can be placed on the central slot game area A1. However, it may be possible that a bet can not be placed on the central slot game area A1. In this case, the slot game is executed on the central slot game area A1 just as an entertaining effect even when any of the slot games on the slot game areas A2 to A11 has met the prescribed condition. Therefore, a payout is not awarded to the player even if a winning combination is achieved in the slot game on the central slot game area A1.

In the above embodiments, the prescribed condition for the execution of the slot game on the slot game area A1 is that a winning combination is achieved on the activated payline in any of the slot games on the slot game areas A2 to A11. However, it may also be possible to regard that the prescribed condition is met only when a specific winning combination (e.g., three APPLEs shown in FIG. 18) is achieved among plural winning combinations. It is also possible to set the prescribed condition that a winning combination (or a specific winning combination) is achieved on the activated payline on a predetermined number (e.g., two) or more of slot game areas A2 to A11.

On the contrary, it may also be possible to set the prescribed condition that a winning combination is not achieved on any of the slot games on the slot game areas A2 to A11.

Further, it is also possible that whether or not the prescribed condition has been met is determined based on the slot games on the slot game areas A2 to A11 on which a bet(s) has been placed. Otherwise, it is also possible that whether or not the prescribed condition has been met is determined based on all of the slot game on the slot game areas A2 to A11 (with or without a bet(s)).

In the above embodiments, two or more of the slot game areas (respectively corresponding to the slot game area provided with the liquid crystal display in claims) A2 to A11 are provided. However, the present invention can be applied to a slot machine having at least one slot game area provided with mechanical reels and at least one slot game area provided with the liquid crystal display.

What is claimed is:

1. A slot machine comprising:
a display which has slot game areas including a slot game area provided with mechanical reels and a slot game area provided with a liquid crystal display panel and displays a slot game on each of the slot game areas, the slot game being a game in which symbols had been displayed on each of the slot game areas are rearranged;
a shutter which is opened to expose the mechanical reels and closed to hide the mechanical reels in the slot game on the slot game area provided with the mechanical reels; and
a controller operable to:
(a) execute the slot game on each of the slot game areas, and
(b) open the shutter in order to expose the mechanical reels for executing the slot game on the slot game area provided with the mechanical reels.

2. The slot machine according to claim 1, wherein
the controller is operable to execute (b) when the slot game executed in (a) has brought an outcome in which a prescribed condition has been met.

3. The slot machine according to claim 2, wherein
the slot game areas include the slot game area provided with mechanical reels and plural slot game areas provided with the liquid crystal display panel, and
the controller is operable to:
execute the slot game on each of the slot game areas provided with the liquid crystal display panel in (a),
open the shutter in order to expose the mechanical reels in (b) when the slot game executed in (a) on any one of the slot game areas has brought the outcome, and
(c) execute the slot game on the slot game area provided with the mechanical reels with the shutter opened.

4. The slot machine according to claim 1, wherein
the shutter is provided with a display device capable of displaying a video shutter, and
the display device displays the video shutter opened to expose the mechanical reels and displays the video shutter closed to hide the mechanical reels.

5. The slot machine according to claim 2, wherein
the outcome is that a winning combination has been achieved in the slot game executed in (a).

6. The slot machine according to claim 5, wherein
the outcome is that a specific winning combination has been achieved among plural kinds of winning combinations in the slot game executed in (a).

7. A slot machine comprising:
a display which has slot game areas including a slot game area provided with mechanical reels and a slot game area provided with a liquid crystal display panel and displays a slot game on each of the slot game areas, the slot game being a game in which symbols had been displayed on each of the slot game areas are rearranged;
a shutter which is opened to expose the mechanical reels and closed to hide the mechanical reels in the slot game on the slot game area provided with the mechanical reels; and
a controller operable to:
(a) execute the slot game on the slot game area provided with the liquid crystal display panel,
(b) open the shutter in order to expose the mechanical reels when the slot game executed in (a) has brought an outcome in which a prescribed condition has been met, and
(c) execute the slot game on the slot game area provided with the mechanical reels with the shutter opened.

8. The slot machine according to claim 7, wherein
the slot game areas include the slot game area provided with mechanical reels and plural slot game areas provided with the liquid crystal display panel, and
the controller is operable to:
execute the slot game on each of the slot game areas provided with the liquid crystal display panel in (a), and
open the shutter in order to expose the mechanical reels in (b) when the slot game executed in (a) on any one of the slot game areas has brought the outcome.

9. The slot machine according to claim 7, wherein
the shutter is provided with a display device capable of displaying a video shutter, and
the display device displays the video shutter opened to expose the mechanical reels and displays the video shutter closed to hide the mechanical reels.

10. A slot machine comprising:
a display which has slot game areas including a slot game area provided with mechanical reels and a slot game area provided with a liquid crystal display panel and displays a slot game on each of the slot game areas, the slot game being a game in which symbols had been displayed on each of the slot game areas are rearranged;
a shutter which is opened to expose the mechanical reels and closed to hide the mechanical reels in the slot game on the slot game area provided with the mechanical reels; and
a controller operable to:
(a) execute the slot game on the slot game area provided with the liquid crystal display panel,
(b) open the shutter in order to expose the mechanical reels when a winning combination has been achieved in the slot game executed in (a), and
(c) execute the slot game on the slot game area provided with the mechanical reels with the shutter opened.

11. The slot machine according to claim 10, wherein
the slot game areas include the slot game area provided with mechanical reels and plural slot game areas provided with the liquid crystal display panel, and
the controller is operable to:
execute the slot game on each of the slot game areas provided with the liquid crystal display panel in (a), and
open the shutter in order to expose the mechanical reels in (b) when a winning combination has been achieved in the slot game executed in (a) on any one of the slot game areas.

12. The slot machine according to claim 10, wherein
the shutter is provided with a display device capable of displaying a video shutter, and
the display device displays the video shutter opened to expose the mechanical reels and displays the video shutter closed to hide the mechanical reels.

13. A slot machine comprising:
a display which has slot game areas including a slot game area provided with mechanical reels and a slot game area provided with a liquid crystal display panel and displays a slot game on each of the slot game areas, the slot game being a game in which symbols had been displayed on each of the slot game areas are rearranged;
a shutter which is opened to expose the mechanical reels and closed to hide the mechanical reels in the slot game on the slot game area provided with the mechanical reels; and
a controller operable to:
(a) execute the slot game on the slot game area provided with the liquid crystal display panel,
(b) open the shutter in order to expose the mechanical reels when a specific winning combination has been achieved among plural kinds of winning combinations in the slot game executed in (a), and
(c) execute the slot game on the slot game area provided with the mechanical reels with the shutter opened.

14. The slot machine according to claim 13, wherein
the slot game areas include the slot game area provided with mechanical reels and plural slot game areas provided with the liquid crystal display panel, and
the controller is operable to:
execute the slot game on each of the slot game areas provided with the liquid crystal display panel in (a), and
open the shutter in order to expose the mechanical reels in (b) when a specific winning combination has been achieved among plural kinds of winning combinations in the slot game executed in (a) on any one of the slot game areas.

15. The slot machine according to claim 13, wherein
the shutter is provided with a display device capable of displaying a video shutter, and
the display device displays the video shutter opened to expose the mechanical reels and displays the video shutter closed to hide the mechanical reels.

16. A playing method of a slot machine for playing a slot game in which symbols had been displayed on a slot game area are rearranged, the method comprising:
(a) executing the slot game on each of slot game areas which include a slot game area provided with mechanical reels and a slot game area provided with a liquid crystal display, and
(b) exposing the mechanical reels for executing the slot game on the slot game area provided with the mechanical reels.

17. A playing method of a slot machine for playing a slot game in which symbols had been displayed on a slot game area are rearranged, the method comprising:
(a) executing a slot game on a slot game area provided with a liquid crystal display panel, and
(b) exposing mechanical reels for executing the slot game on a slot game area provided with the mechanical reels when the slot game executed in (a) has brought an outcome in which a prescribed condition has been met.

18. The playing method of a slot machine according to claim 17, wherein
the slot game areas include the slot game area provided with mechanical reels and plural slot game areas provided with the liquid crystal display panel, and
the mechanical reels are exposed in (b) when the slot game executed in (a) on any one of the plural slot game areas has brought the outcome.

19. A playing method of a slot machine for playing a slot game in which symbols had been displayed on a slot game area are rearranged, the method comprising:
(a) executing the slot game on a slot game area provided with a liquid crystal display panel, and
(b) exposing mechanical reels for executing the slot game on a slot game area provided with the mechanical reels when a winning combination has been achieved in the slot game executed in (a).

20. The playing method of a slot machine according to claim 19, wherein
the slot game areas include the slot game area provided with mechanical reels and plural slot game areas provided with the liquid crystal display panel, and
the mechanical reels are exposed in (b) when a winning combination has been achieved in the slot game executed in (a) on any one of the plural slot game areas.

21. A playing method of a slot machine for playing a slot game in which symbols had been displayed on a slot game area are rearranged, the method comprising:
(a) executing a slot game on a slot game area provided with a liquid crystal display panel, and
(b) exposing mechanical reels for executing the slot game on a slot game area provided with the mechanical reels when a specific winning combination has been achieved among plural kinds of winning combinations in the slot game executed in (a).

22. The playing method of a slot machine according to claim 21, wherein
the slot game areas include the slot game area provided with mechanical reels and plural slot game areas provided with the liquid crystal display panel, and
the mechanical reels are exposed in (b) when a specific winning combination has been achieved among plural kinds of winning combinations in the slot game executed in (a) on any one of the plural slot game areas.
